(19) United States
(12) Patent Application Publication
(10) Pub. No.: US 2024/0345406 A1
(43) Pub. Date: Oct. 17, 2024

(54) ADAPTABLE HIGH PERFORMANCE NEURAL INTERFACE ELECTRODES THAT CONFORM TO HUMAN ANATOMY

(71) Applicant: Cognixion Corporation, Santa Barbara, CA (US)

(72) Inventors: Joseph Andreas Forsland, Santa Barbara, CA (US); Christopher Jason Ullrich, Ventura, CA (US)

(73) Assignee: Cognixion Corporation, Santa Barbara, CA (US)

(21) Appl. No.: 18/633,385

(22) Filed: Apr. 11, 2024

Related U.S. Application Data
(60) Provisional application No. 63/495,484, filed on Apr. 11, 2023.

(51) Int. Cl. G02B 27/01

(52) U.S. Cl. CPC G02B 27/0176

(57) ABSTRACT

An electrode assembly and a system including it are disclosed. The electrode assembly includes an electrode body with arc rail(s) attached to and extending from the electrode body. The arc rail(s) include at least one sensing element for sensing or stimulating the state of a particular property of a selected subject area when applied by the arc rail to that area. The arc rail is so disposed in relation to the electrode body as to be disposed at a non-perpendicular angle to the subject area when the electrode assembly is applied to the selected subject area. The system includes an analog front end (AFE) configured to receive output signals from at least one electrode assembly and transmit the output signals to a digital module for processing. The system also includes an accessory strap with sockets to receive electrode assemblies and deliver their outputs to the AFE.

### CROSS-REFERENCE TO RELATED APPLICATIONS

This application claims the benefit of U.S. provisional patent application Ser. No. 63/495,484, filed on Apr. 11, 2023.

### BACKGROUND

Existing non-invasive brain computer interfaces (BCIs) rely on specialized electrode material in order to present a biocompatible but low-impedance electrical interface to the human skull. Existing solutions that utilize conductive polymers suffer from poor mechanical conformance to the curved skull surface, hair obstruction, and electrical insulation created by the outer dermal layer. This suboptimal combination has led the current state of the art in electrodes to be bulky and uncomfortable while providing inconsistent and poor bioelectrical data transfer through the electrode sensor. The current state of the art for non-invasive electrodes does not include designs that function well in dynamic, real-world conditions outside of a laboratory or controlled environment or for extended periods of usage time.

Some conventional approaches rely on low-durometer polymers to reduce the discomfort felt by users. They further either rely on conductive gels and pastes, or embedded amplification in the electrode to overcome impedance and noisy bioelectric signals. Gel- or paste-type electrode sensors are messy and may need significant maintenance. They may also only be useful for a limited duration, as their efficacy decreases as the gel or paste dries out.

Other conventional approaches apply direct, perpendicular pressure on the skin and thus become extremely painful over time, especially when used in areas of the body with little to no fat or muscle tissue, such as the skull. Conventional approaches may have post or leg geometry and may resemble a brush or comb. As these electrodes move laterally across the scalp or skin, they tend to give a “raking” sensation which is painful.

There is, therefore, a need for efficient electrodes that are interoperable with a BCI as well as suitable for comfortable, long-duration wearability under real-world consumer use conditions.

### BRIEF SUMMARY

In one aspect, an electrode assembly includes an electrode body, and at least one arc rail attached to and extending from the electrode body, where the at least one arc rail includes at least one sensing element for sensing the state of a particular property of a selected subject area when the sensing element is applied by the at least one arc rail to the selected subject area, and where the at least one arc rail is so disposed in relation to the electrode body as to be disposed at a non-perpendicular angle to the selected subject area when the electrode assembly is applied to the selected subject area.

In one aspect, a system includes an analog front end (AFE) configured to receive output signals from at least one electrode assembly and transmit the output signals to a digital module for processing. The system also includes an accessory strap including sockets to receive the at least one electrode assembly and configured to deliver the output signals from the at least one electrode assembly to the AFE. The at least one electrode assembly includes an electrode body, and at least one arc rail attached to and extending from the electrode body, where the at least one arc rail includes at least one sensing element for sensing the state of a particular property of a selected subject area when the sensing element is applied by the at least one arc rail to the selected subject area, and where the at least one arc rail is so disposed in relation to the electrode body as to be disposed at a non-perpendicular angle to the selected subject area when the electrode assembly is applied to the selected subject area.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates the anatomy of human skin and hair 100.

FIG. 2A-FIG. 2C illustrate conventional electrodes 200.

FIG. 3A-FIG. 3C illustrate conventional electrodes engaged with skin 300.

FIG. 4A-FIG. 4G illustrate an electrode 400 in accordance with one embodiment. FIG. 4A provides an isometric view, FIG. 4B provides a top plan view, FIG. 4C provides a bottom plan view, FIG. 4D provides a side elevation view, FIG. 4E provides a front elevation view, FIG. 4F provides a front elevation cross-section view, and FIG. 4G provides a detailed view of the contact surface.

FIG. 5A-FIG. 5H illustrate additional electrode designs 500 in accordance with one embodiment.

FIG. 6A-FIG. 6C illustrate comparative responses under use pressure 600 in accordance with one embodiment.

FIG. 7A-FIG. 7C illustrate advantages of different electrode geometries 700 in accordance with various embodiments.

FIG. 8 illustrates a conventional connection to an electrode cable 800.

FIG. 9A and FIG. 9B illustrate a connection to electrode cables 900 in accordance with one embodiment.

FIG. 10 illustrates a microneedle array 1000 in accordance with one embodiment.

FIG. 11 illustrates an electrode engaged with skin 1100 in accordance with one embodiment.

FIG. 12 illustrates microneedles engaged with skin 1200 in accordance with one embodiment.

FIG. 13A-FIG. 13C illustrate additional sensing device configurations 1300 in accordance with one embodiment.

FIG. 14-FIG. 17 illustrate exemplary embodiments of BCI-equipped or BCI-compatible headgear including the electrodes disclosed herein.

FIG. 18 illustrates a fabrication routine 1800 in accordance with one embodiment. FIG. 19 illustrates a use routine 1900 in accordance with one embodiment.

### DETAILED DESCRIPTION

A mechanical assembly is disclosed herein that may adapt to the shape of the human skull and other curvaceous body parts. In one embodiment, the disclosed assembly may perforate the outer dermal layer for improved electrical conductivity and sensing. The disclosed solution may provide bioelectric and biomechanical sensing with much higher fidelity (as measured by signal-to-noise ratio) than existing sensor geometries. The result of this higher fidelity may be reduced latency and increased usability of brain computer interfaces (BCIs). The disclosed designs may support the widespread deployment of augmentative and accessibility technologies for mass-market devices as well as utility in mass-market applications such as mobile, augmented reality, virtual reality, and mixed reality.

The disclosed solution may further support improvements to other biosensing devices such as electroencephalography (EEG), electrocardiography (ECG or EKG), electromyography (EMG), electrooculography (EOG), or other electromagnetic field-based sensing, collectively referred to herein as “EXG”, as well as potential biomechanical sensing of subtle movements, state changes, and events within the body. Smart material configurations of this solution may also register local mechanical or chemical changes in the surface properties of skin, which may be indicative of blood flow, humidity, or other biological indicators.

The disclosed solution is a dry electrode with additional sensing devices or strips comprising microneedle arrays disposed along flexible arc rails. Such electrodes may have a number of key advantages over existing bioelectric sensors (especially those used for EEG). Electrodes of the disclosed designs may predictably conform to local skull shape without user discomfort. They may mechanically separate hair to promote direct dermal contact of the electrode surface. They may perforate the outer ˜80 μm of the skin (i.e., the epidermis), reaching beyond the skin's surface, which has a high electrical resistance. They may support the design flexibility of the surface contact area without adding more complexity. They may be designed to deform progressively, providing suspension as pressure is applied. They may flex symmetrically or asymmetrically, as most suits the intended location or application. They may utilize a rail geometry instead of post/leg geometry. They may be designed with multiple arc rails. Their arc rails may be designed to move through hair more easily than post/leg geometry. They may conform to small-radius and nonuniform surfaces of curved body parts.

In contrast to conventional electrode designs, the disclosed electrodes may eliminate the need for messy liquids or gels. They may be designed to reduce maintenance effort, time, and cost. The disclosed solution may also improve impedance and reduce bioelectric noise in the signal with or without amplification or gels/pastes. The disclosed, progressively flexing, asymmetrical designs may mitigate or eliminate the sensation of pressure on the scalp or body when perpendicular pressure is exerted. The disclosed solution may glide across the skin when it moves, making the electrodes almost imperceptible to touch.

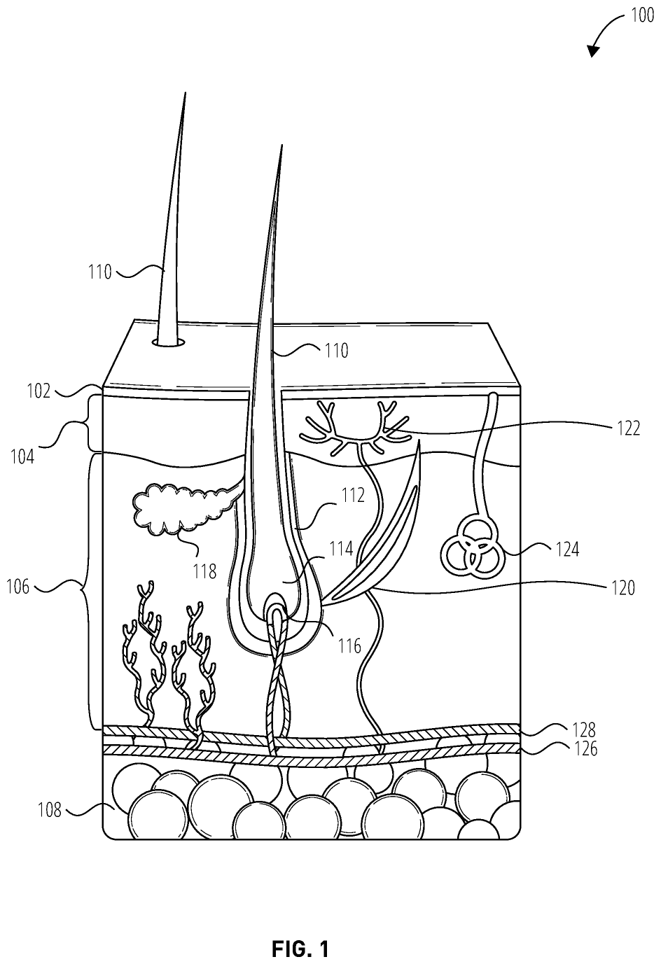

FIG. 1 illustrates the anatomy of human skin and hair 100. The anatomy of human skin and hair 100 comprises the stratum corneum 102, the epidermis 104, the dermis 106, adipose tissue 108, hair shafts 110, hair follicles 112, hair bulbs in the follicles 114, dermal papillae 116, sebaceous glands 118, arrector pili muscles 120, nerves 122, sweat glands 1242, arteries 126, and veins 128.

Electrodes placed on the surface of the skin may, through the proximity and electrical behaviors of these structures and nearby underlying organs, be able to measure heart activity, nervous activity, muscle movement, perspiration levels, and a number of other properties that may be indicative of health, physical movement, mental volition and intention, and mood.

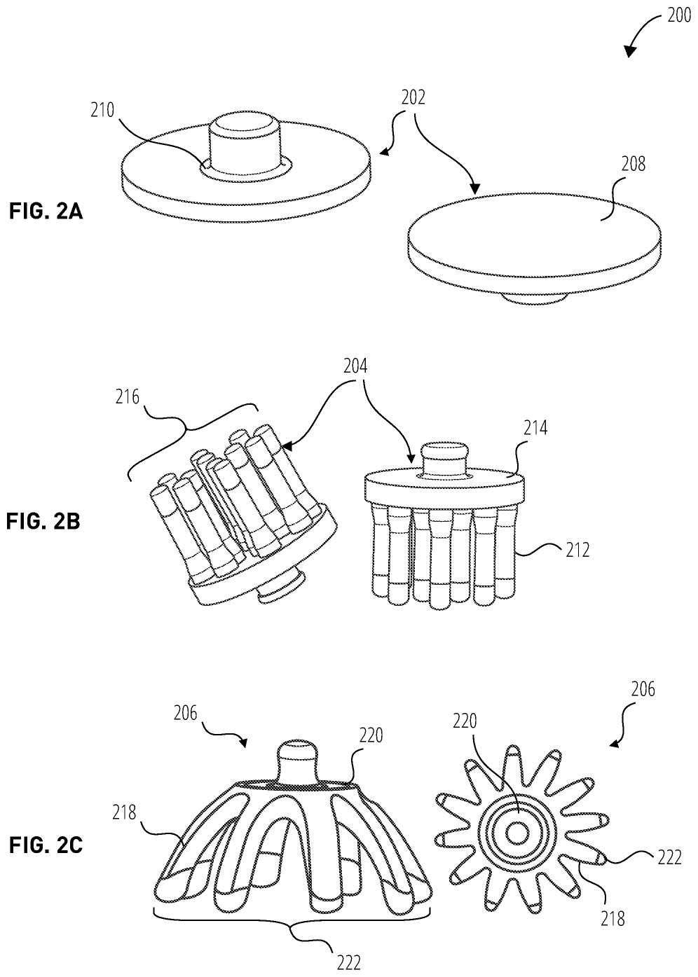

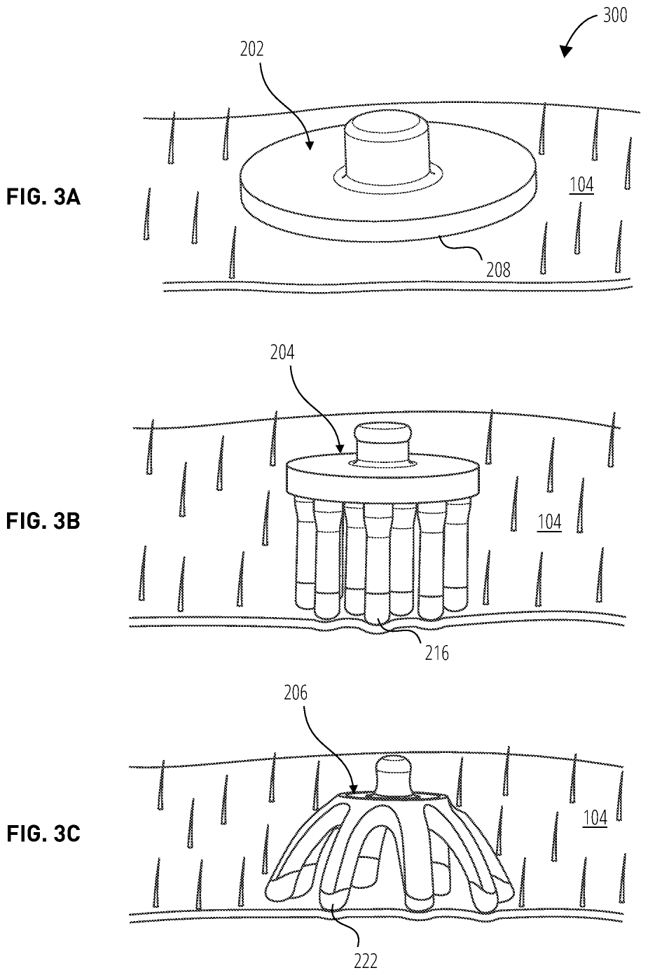

FIG. 2A-FIG. 2C illustrate conventional electrodes 200. Conventional electrode 200 may include gel- or paste-type electrodes 202 and post- or leg-type electrodes 204 and 206. The gel- or paste-type electrodes 202 may include a gel or paste conductive contact surface 208 which may be positioned upon a skin surface as illustrated in FIG. 3A. The gel or paste conductive contact surface 208 may be capable of transmitting electrical signals from the skin surface to an electrical connection point on the connector base 210.

The post- or leg-type electrodes 204 may include posts 212 attached to a connector base 214 and tipped with conductive contact surfaces 216. The conductive contact surfaces 216 may be in contact with a skin surface as shown in FIG. 3B. The conductive contact surfaces 216 and posts 212 may be capable of transmitting electrical signals from the skin surface to an electrical connection point on the connector base 214.

The post- or leg-type electrodes 206 may include legs 218 attached to a connector base 220 and tipped with conductive contact surface 222. The conductive contact surfaces 222 may be in contact with a skin surface as shown in FIG. 3C. The conductive contact surfaces 222 and legs 218 may be capable of transmitting electrical signals from the skin surface to an electrical connection point on the connector base 220. The legs 218 may spread outward like spider legs or daisy petals as pressure is applied, as shown in FIG. 2C.

The overall chemical composition of skin and hair is 45% carbon, 28% oxygen, 15% nitrogen, 7% hydrogen, and 5% sulfur. The surface of the skin's outer surface, as well as surface hairs, are essentially composed of keratin. Keratin is a compact, strong, fibrous protein that is gradually formed inside cells from the germinal layer. However, keratin is in general a poor conductor of electricity. Its conductivity may be improved through the addition of moisture.

For this reason, gel- or paste-type electrodes 202, such as are shown in FIG. 2A may exhibit better performance (lower signal-to-noise ratios) when placed in contact with the skin surface than dry electrodes, such as post- or leg-type electrodes 204 and 206 shown in FIG. 2B and FIG. 2C, respectively. The gel or paste on the gel or paste conductive contact surface 208 includes moisture that enhances conductivity, thus providing a clearer signal at the connector base 210 electrical connection point. However, the gel or paste eventually dries out, making gel- or paste-type electrodes 202 less durable and reusable than dry electrodes.

Dry electrodes such as the post- or leg-type electrodes 204 and 206 may be more durable and reusable. However, because the signals they are able to detect and conduct are attenuated by the resistance presented by dry keratin surfaces, noise from other electrical fields in the vicinity may introduce noise, reducing their electrical performance.

FIG. 3A-FIG. 3C illustrate conventional electrodes engaged with skin 300. FIG. 3A shows a gel- or paste-type electrode 202 placed on a skin surface. The gel or paste conductive contact surface 208 rests in contact with the outer surface of the epidermis 104. FIG. 3B shows a post- or leg-type electrode 204 placed on a skin surface. The conductive contact surfaces 216 rest in contact with the outer surface of the epidermis 104. FIG. 3C shows a post- or leg-type electrode 206 placed on a skin surface. The conductive contact surfaces 222 rest in contact with the outer surface of the epidermis 104.

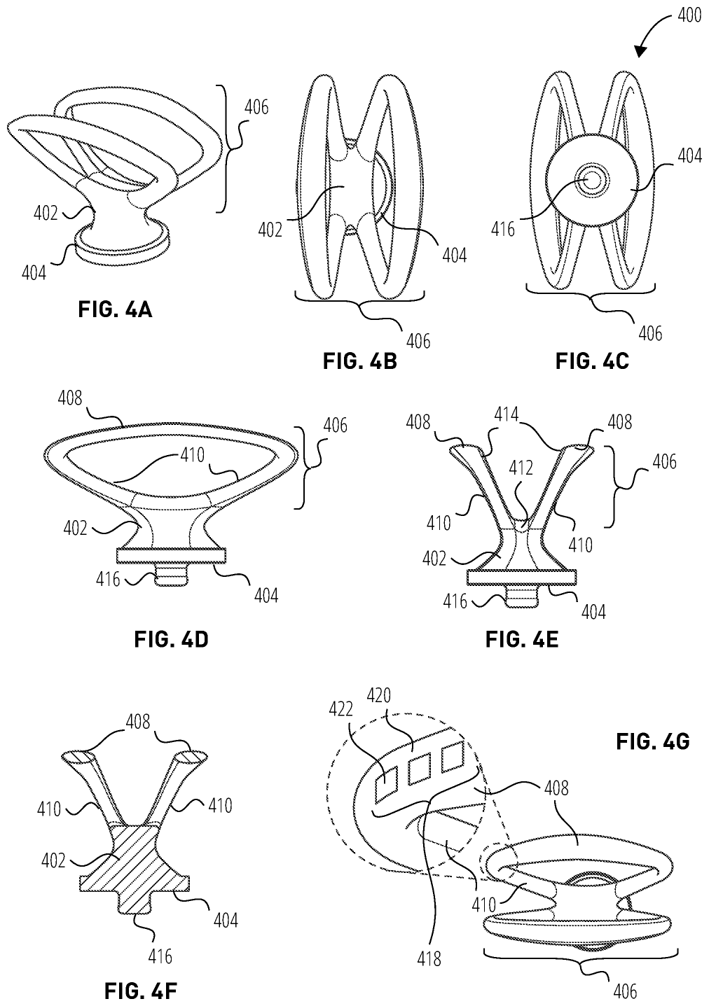

FIG. 4A-FIG. 4G illustrate an electrode 400 and the parts comprised in the electrode assembly disclosed herein, in accordance with one embodiment. FIG. 4A provides an isometric view, FIG. 4B provides a top plan view, FIG. 4C provides a bottom plan view, FIG. 4D provides a side elevation view, FIG. 4E provides a front elevation view, FIG. 4F provides a front elevation cross-section view, and FIG. 4G provides a detailed view of the contact surface. In some aspects described herein, the disclosed electrodes may be referred to as electrode assemblies. “Electrode assembly” as used herein refers to the set of physical elements in various configurations that comprise the claimed components included in what is commonly known in the art as an “electrode”. Thus for the purposes of this disclosure, the terms “electrode assembly” and “electrode” may be considered equivalent and may be used interchangeably.

The disclosed electrode 400 may be a dry electrode, or in some embodiments may be used in combination with suitable gels as a wet electrode. The electrode 400 may be configured as a passive electrode or an active electrode. Passive electrodes may comprise electromagnetically sensitive materials such that the fluctuations in the body's electromagnetic fields may induce a voltage fluctuation in the electrode which the electrode may transmit through a wire to devices configured to amplify, transform, analyze, and report upon those signals. Active electrodes are configured with preamplification components to enhance the voltage fluctuations induced in the electrode for improved electrode performance.

The electrode 400 may comprise an electrode body 402 attached to a connector base 404 at one end and supporting at least one arc rail 406 attached to and extending from the arc rail 406 at its other end. The arc rails 406 may include a rail 408 attached to the electrode body 402 through at least one arc rail brace 410. The embodiment illustrated herein includes two rails 408 each supported at both ends by an arc rail brace 410, but other embodiments may provide one, three, or multiple arc rails 406, and may provide a rail 408 supported either at one end or at some other single point along its length by a single arc rail brace 410. In this manner, an arc rail 406 comprising a rail 408 supported by two arc rail braces 410 may form a full loop as shown, or an arc rail 406 may form a partial loop. The partial loop may be formed by a rail 408 supported by and held out from the electrode body 402 by a single arc rail brace 410 at one end of the rail 408.

The electrode assembly may also include mechanical features that modify the deformation characteristics and the sensing characteristics of the electrode assembly. In one embodiment, such features may be provided at the arc rail brace junctions 412 and inner arc rail edges 414 to increase or decrease the ability of the arc rails 406 to flex apart.

The connector base 404 may include an electrical connection point 416. This electrical connection point 416 may comprise an industry-standard male snap connector. This may support connection to common existing sensing equipment using easy-to-find standard snap cables. Other electrical connection configurations may also be designed, using either standard or customized form factors.

Arc rails 406 may include at least one sensing element 418 intended to contact a selected subject area such as a skin surface. The sensing elements 418 may sense the state of a particular property of the selected subject area when the sensing element is applied by the arc rail 406 to the selected subject area. In one embodiment, the sensing elements 418 may measure electromagnetic activity. In one embodiment, the sensing element 418 may be driven as a stimulation element. For example, an electrode 400 configured with such a sensing element 418 may induce high-energy sound waves which may detected in the body as sonogram signals.

Each rail 408, arc rail 406, or even an entire electrode may be made from, coated with, or equipped with EXG sensing material 420, such that the entire structure comprises a sensing element 418. Such materials may include electromagnetic polymers, mesh, plating, coating, or embedded wire formed from high-conductivity metals such as gold or spluttered silver or other materials such as graphene.

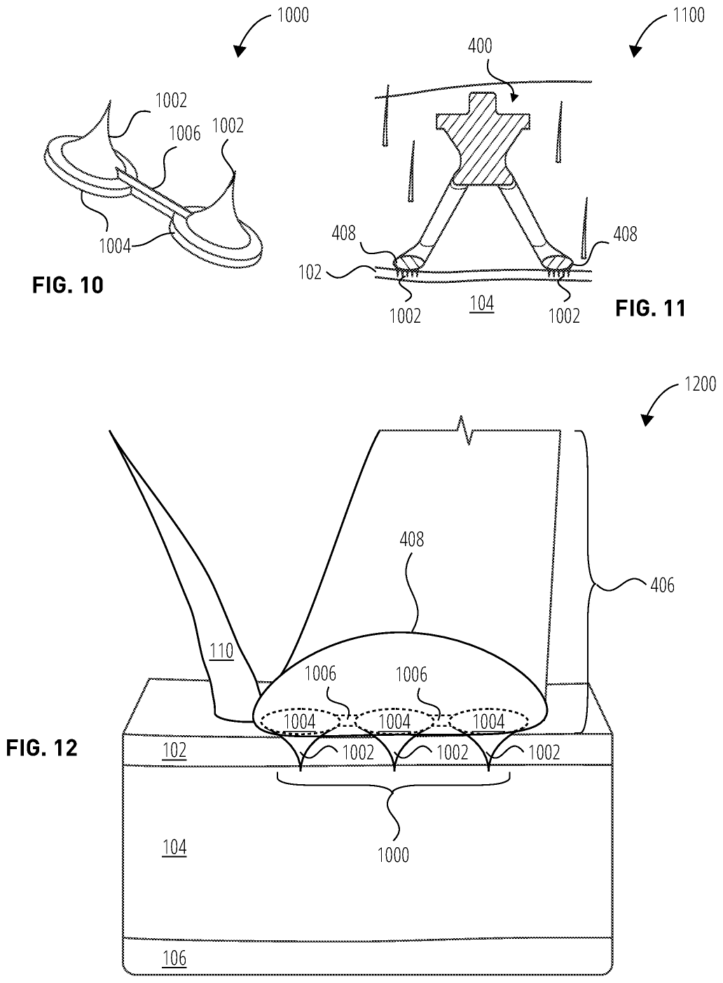

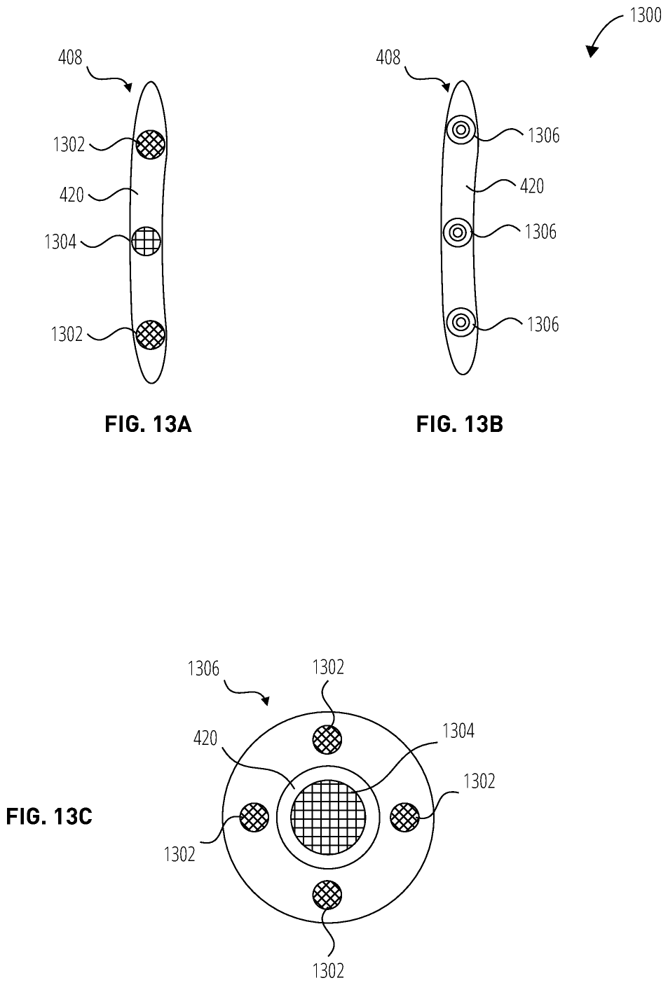

Additionally or alternatively, each rail 408 may include EXG sensing material 420 and may also be configured with sensing pads 422. The EXG sensing material 420 and/or the sensing pads 422 may include microneedle arrays, illustrated in their most fundamental form in FIG. 10. The sensing pads 422 may be formed from coatings of additional or alternative materials known to be useful in the art. The sensing pads 422 may in some embodiments incorporate small sensors supporting additional sensing technologies as illustrated in FIG. 13A-FIG. 13C.

While the illustrated sensing pads 422 are shown as squares configured in a single row along the length of the arc rail 406, this configuration is provided as one example and is not intended to be limiting. One of ordinary skill in the art will readily apprehend that the sensing pads 422 may be linear, ellipsoid, or polygonal, may vary in aspect ratio from what is shown, may be configured in arrays wider than the single row shown, may alternate in offset from a center line along the arc rail 406, etc.

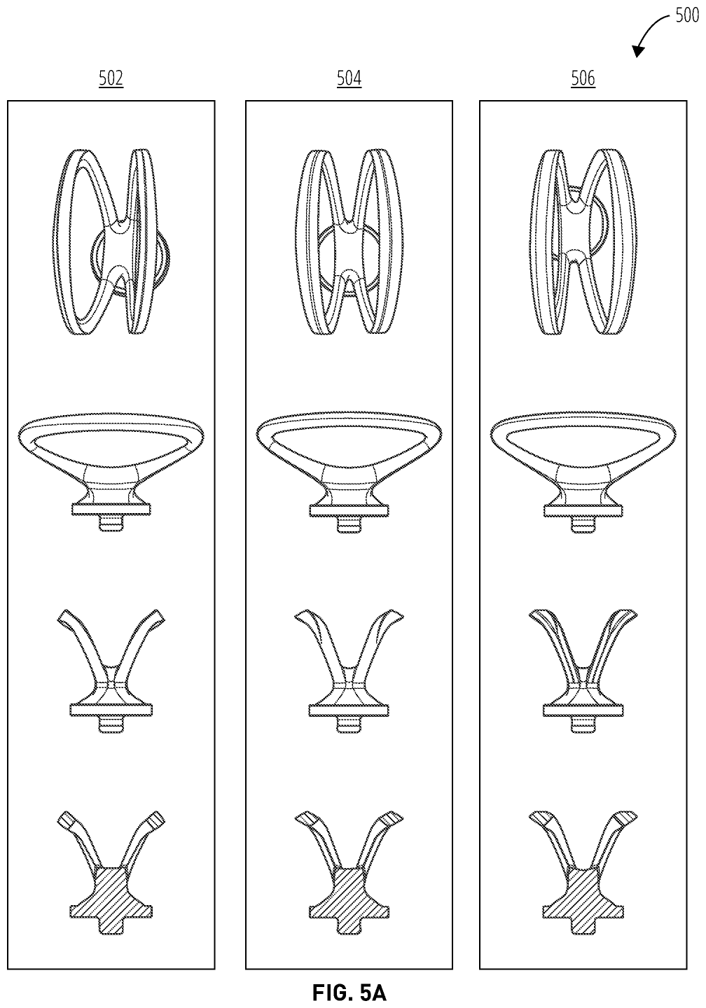

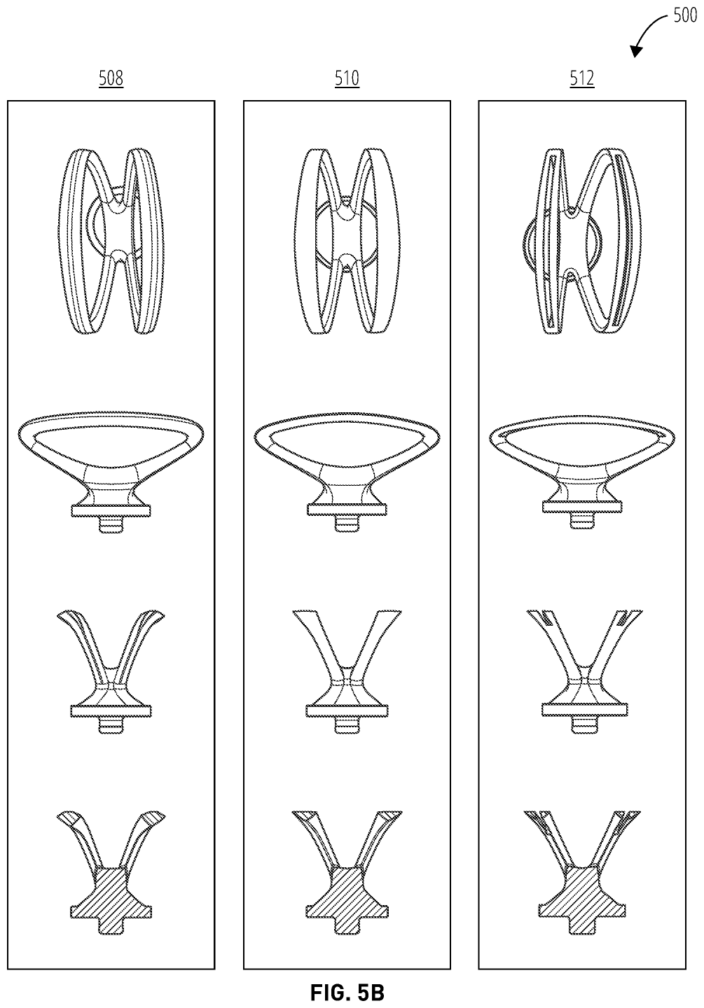

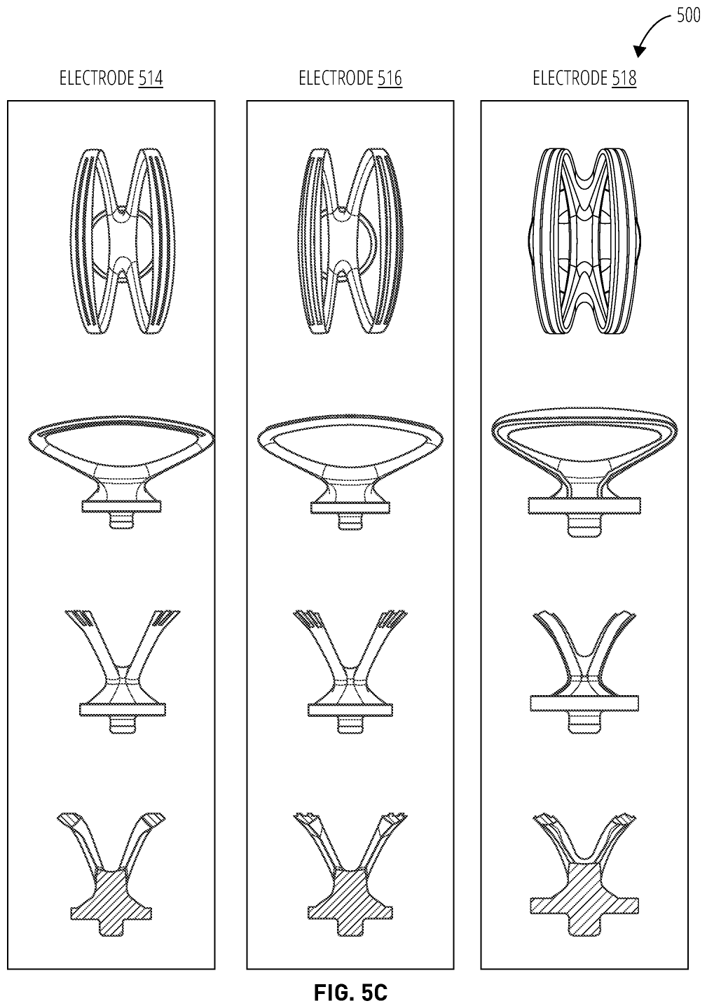

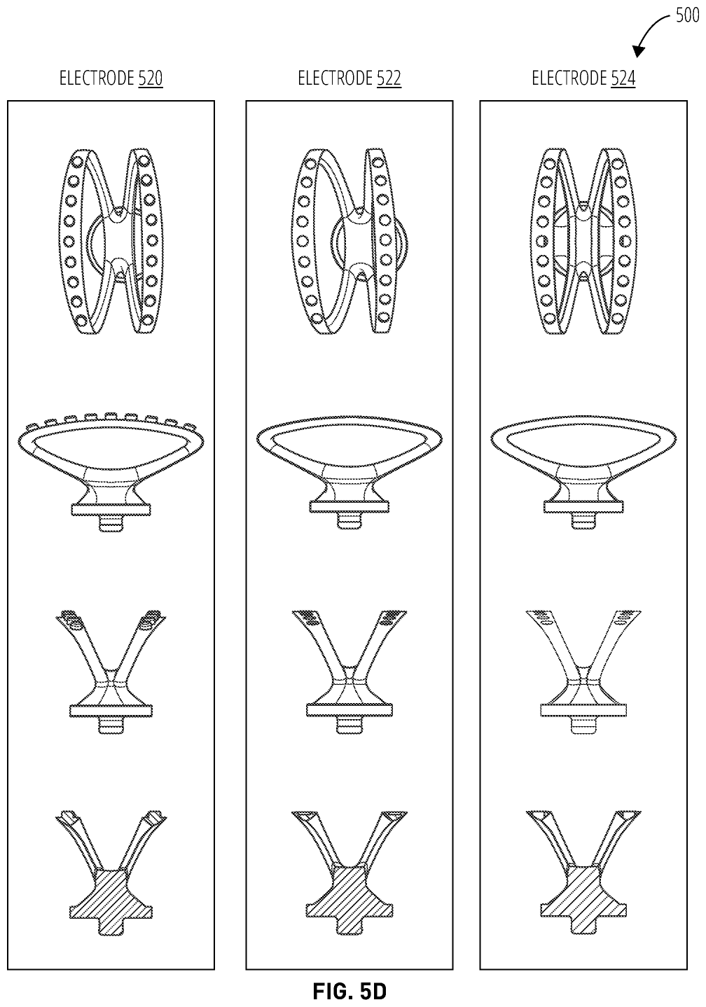

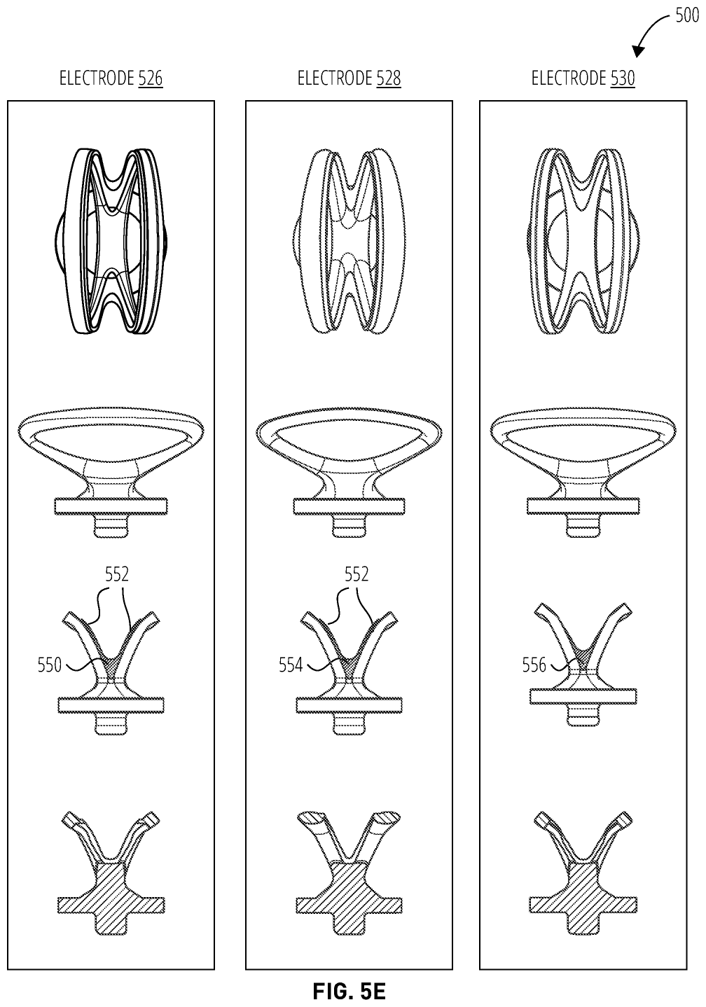

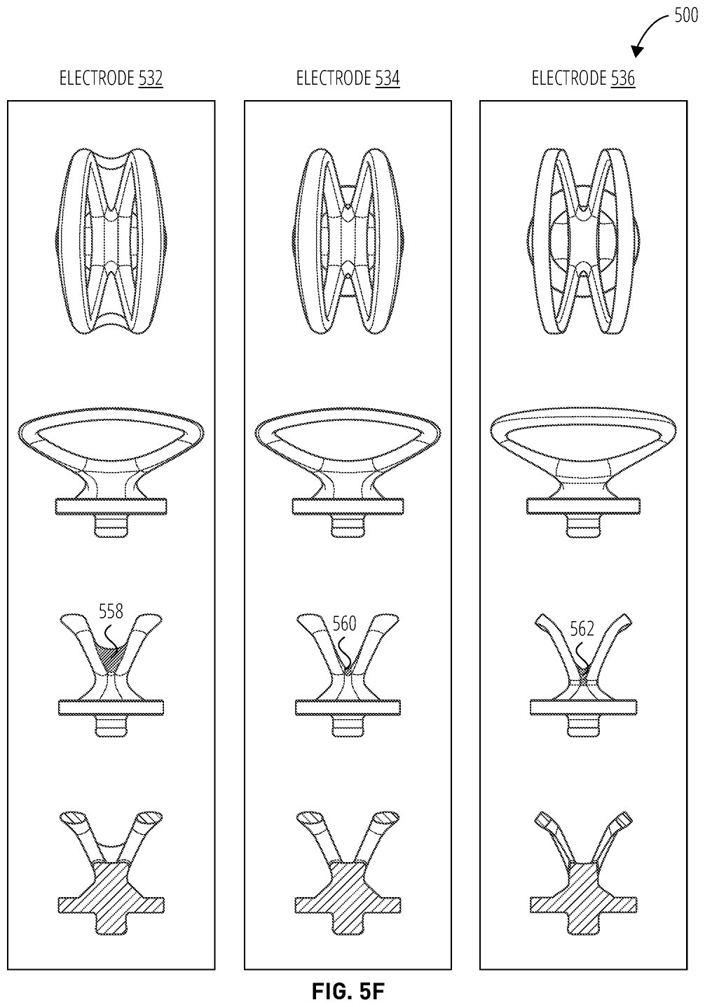

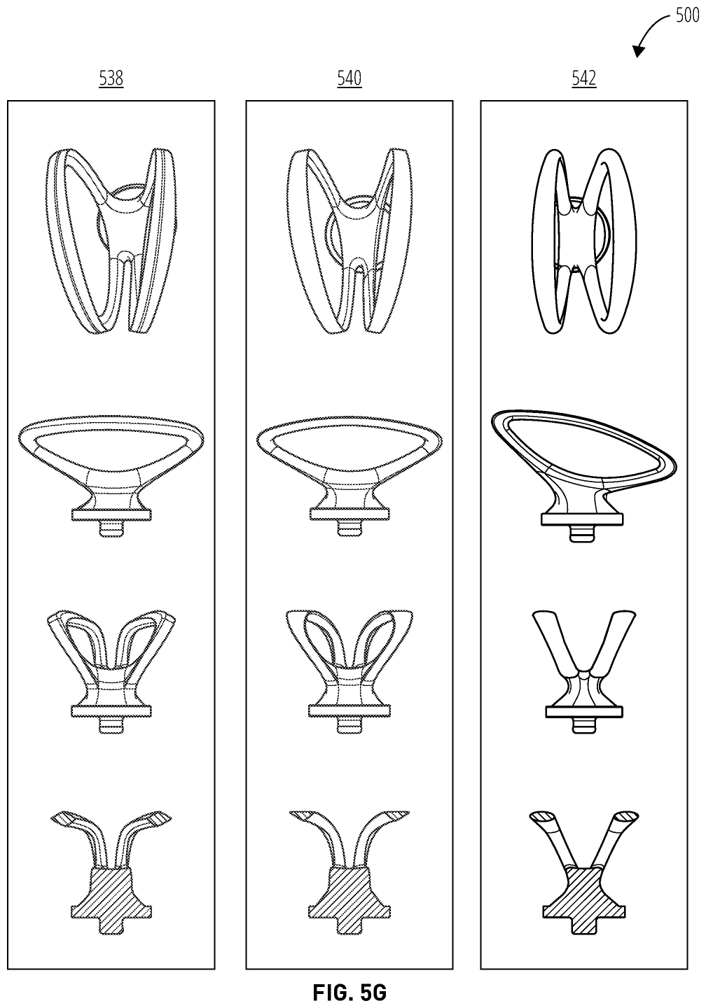

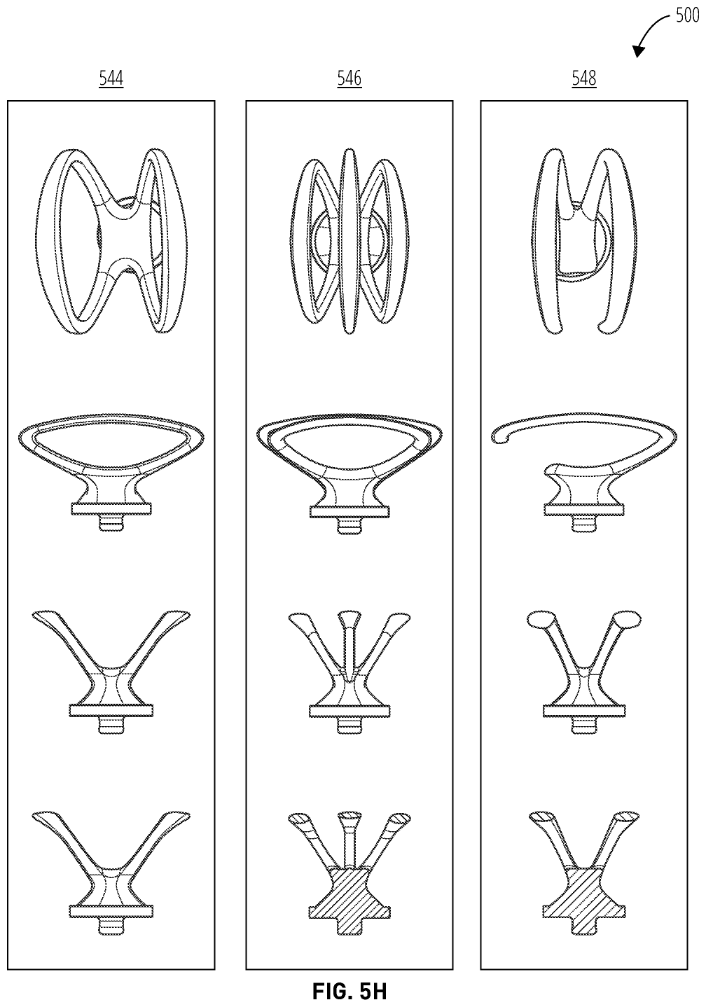

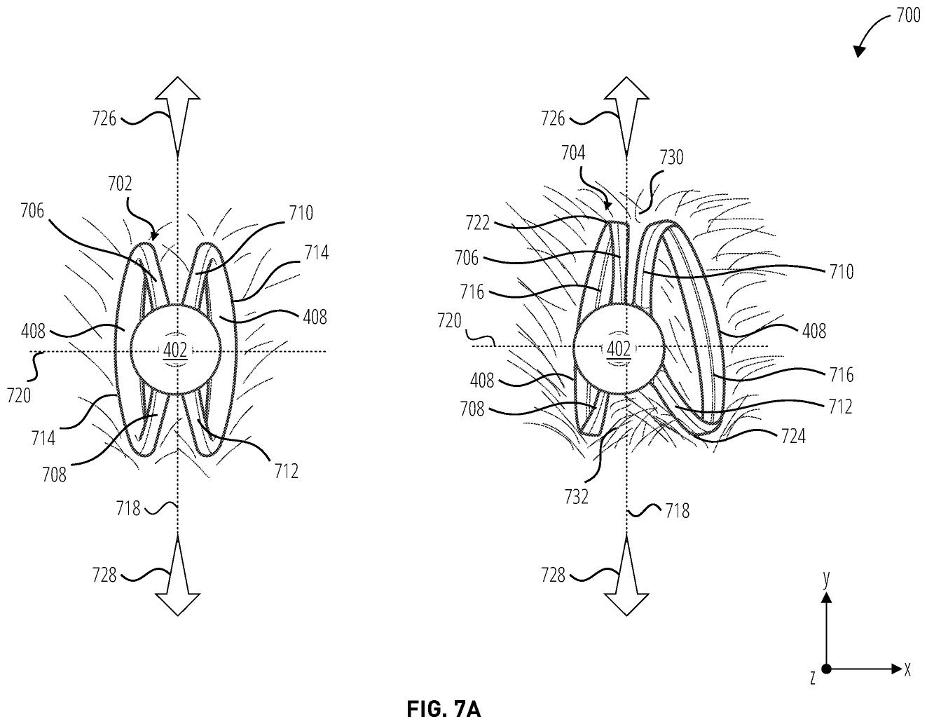

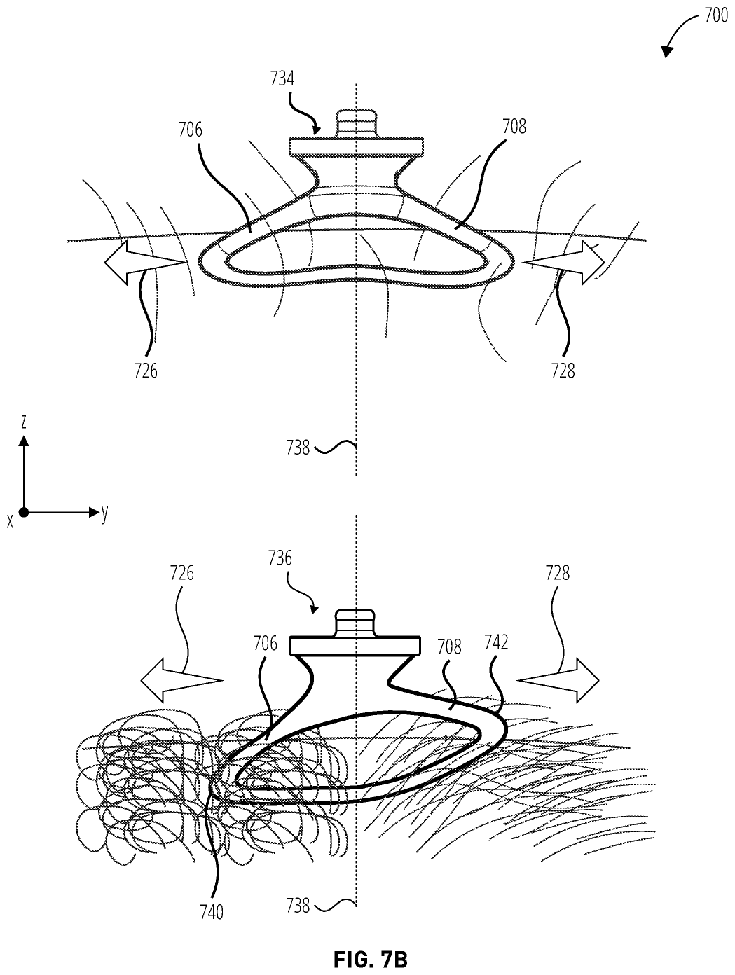

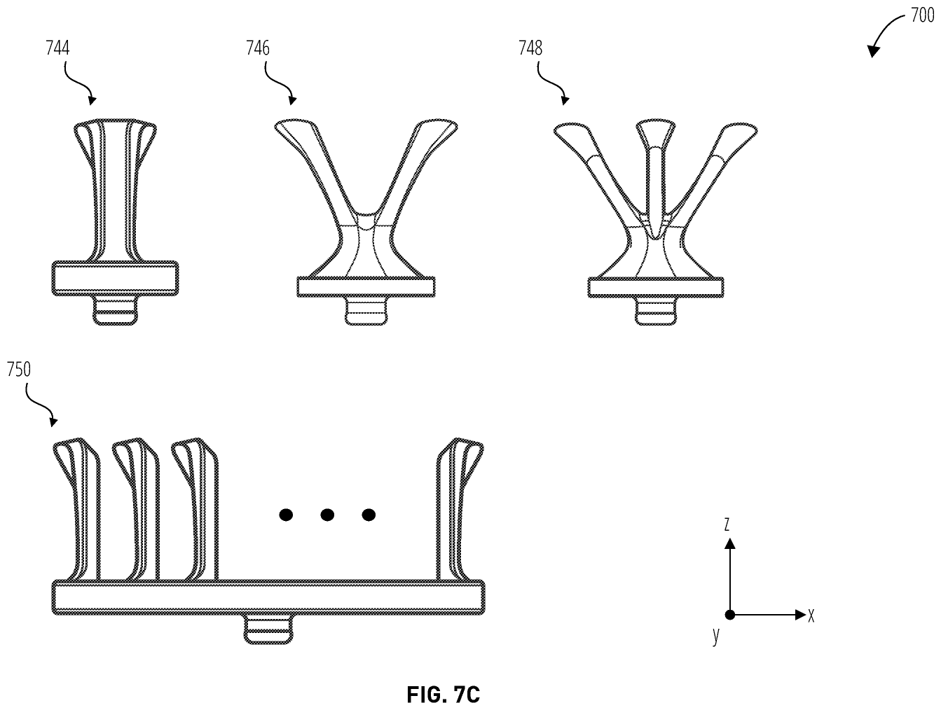

The electrode assembly may also include mechanical features that modify the sensing characteristics of the electrode assembly. Such mechanical features may include slits, ridges, bumps, grooves, divots, holes, dimples, an overmolded substrate, an at least partially encapsulating or encapsulated substrate, a conductive coating, and an arc rail brace. Additional examples are provided and described with respect to the electrodes illustrated in FIG. 5A-FIG. 5H, FIG. 7C, FIG. 9A and FIG. 9B, FIG. 11, FIG. 13A-FIG. 13C, and FIG. 17.

FIG. 5A-FIG. 5H illustrate additional electrode designs 500 in accordance with one embodiment. The additional electrode designs 500 may include electrodes 502-546. Electrodes may be configured with different rail cross-sectional geometries, rail contact surface features, arc rail spacing configurations, and arc rail quantities, as illustrated by the designs illustrated herein. This variety of arc rail configurations, in conjunction with a common electrode body with an industry-standard electrical connection point, such as a male snap connector, may allow an array of electrodes to be optimized for specific applications and wearers while remaining easily interchangeable and broadly useful in existing sensing applications.

The illustrated embodiments exhibit a variation in their rail cross-sectional geometry, as shown in the cross-sectional views provided for each design. Each cross-sectional geometry supports advantageous behavior under different applications. Diamond cross-sectional geometry, as seen in electrode 502, electrode 504, electrode 506, electrode 508, electrode 526, electrode 530, electrode 536, and electrode 538, may provide improved skin contact when used in densely-haired areas due to the ability of the edges provided by such geometry to part and thus move more easily through hair to remain in contact with skin, as described in greater detail with respect to FIG. 7A and FIG. 7B. Including bezels along the edges of these cross-sections, such as is shown in electrode 506 and electrode 508, may improve comfort and contact surface area while retaining the edges that facilitate passage through hair.

Smooth cross-sectional geometry, such as oval cross-sectional geometry, as seen in electrode 400, electrode 528, electrode 532, electrode 534, electrode 542, electrode 544, electrode 546, and electrode 548, as well as the triangular cross-sectional geometry seen in electrode 510 and electrode 540, and the flat cross-sectional geometry seen in electrode 512, electrode 514, and electrode 516, may not move through dense hair as easily but may provide a more comfortable experience when in contact with a wearer's skin. Triangular and flat cross-sectional geometry may maintain a broader contact area than the oval as the electrodes move in response to the wearer's movements.

Flat cross-sectional geometries, as seen in electrode 512, electrode 516, electrode 514, electrode 520, electrode 522, and electrode 524, may provide a broader and more uniform contact surface within which mechanical features such as rail contact surface features may be configured, including slits (electrode 512 and electrode 514), ridges (electrode 516 and electrode 518), bumps (electrode 520), divots (electrode 522), and holes (electrode 524). Features such as bumps, divots, holes, slits, and ridges, may support the installation of additional sensors or a variety of sensing materials, such as the microneedle arrays 1000 and additional sensing device configurations 1300 illustrated in FIG. 10 and FIG. 13A-FIG. 13C, respectively, and described in greater detail below. Ridges may provide improved contact area over diamond options while supporting a smoother passage and better contact through thicker hair. Grooves, slits, divots, and holes may allow the electrode to hold gels, which may improve the performance of the electrodes in certain applications.

Features may be provided at the arc rail brace junctions and inner arc rail edges to increase or decrease the ability of the arc rails to spread apart by increasing the rigidity or flexibility of the arc rail and arc rail brace structures. Adding a deeper, thicker web 550 of material at the arc rail brace junction 412 that extends in ridges 552 up the arc rail braces 410 and along the inner arc rail edges 414, as seen in electrode 526, may provide a great reduction of flex between the arc rails, while a shallower, thicker web 554 extending to similar ridges 552, as seen in electrode 528, may provide lower but still high flex reduction. The ridges 552 across the arc rails may also provide additional contact area. A thicker web 556 extending to ridges 552 confined to the arc rail braces 410, as seen in electrode 530, may provide moderate flex reduction, and a thinner web 558 with no ridges, as seen in electrode 532, may provide light flex reduction. Alternatively, a shallower groove 560 at the arc rail brace junction 412, as seen in electrode 534, may increase flex between the arc rails. A deeper, broader groove 562, as seen in electrode 536, may provide the greatest flex increase.

Asymmetries in arc rail spacing configurations, such as are seen in electrode 538, electrode 540, and electrode 542, may further facilitate passage of the electrodes through dense hair while maintaining solid skin contact, as is described in greater detail with respect to FIG. 7A and FIG. 7B. Variation in arc rail spacing configurations may also allow electrodes to incorporate wider arc rail spacing, such as is seen in electrode 544, which may take up more room when installed in a sensing device, but may provide more stable skin contact in applications where much user movement is expected. Variations in arc rail quantity, such as the three arc rails of electrode 546, may facilitate design improvements as described with respect to FIG. 7C. An electrode may be configured with partial loop arc rails as shown in electrode 548. The partial loop may be formed by a rail 408 supported by and held out from the electrode body by a single arc rail brace at one end of the rail.

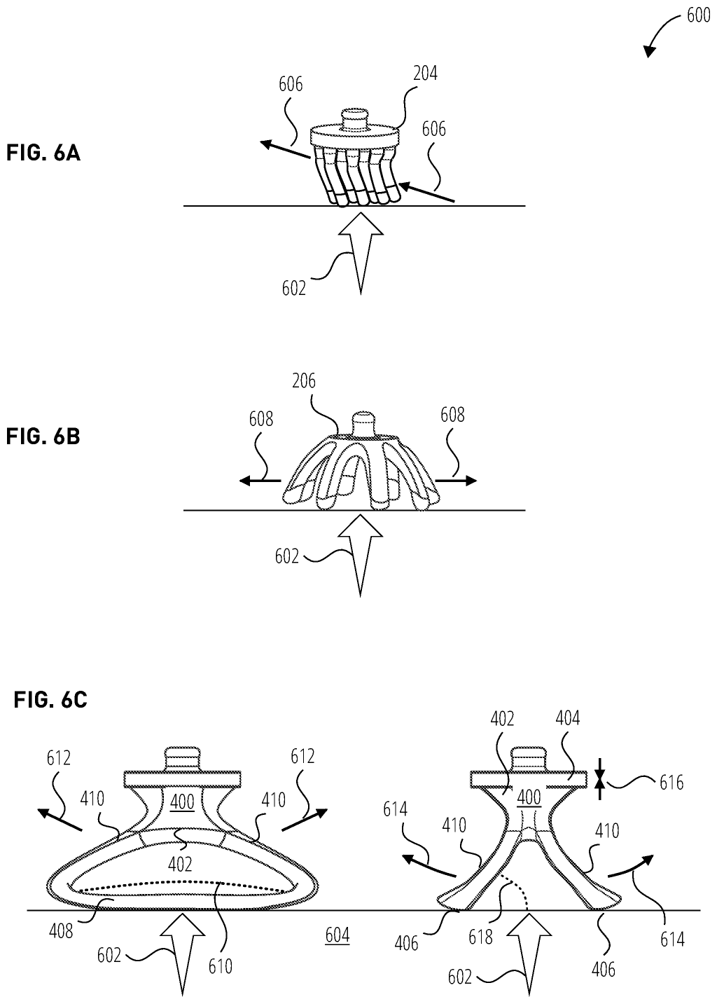

FIG. 6A-FIG. 6C illustrate comparative responses under use pressure 600 in accordance with one embodiment. Such responses are illustrated for one conventional post- or leg-type electrode 204 in FIG. 6A, another post- or leg-type electrode 206 in FIG. 6B, and the electrode 400 disclosed herein in FIG. 6C.

The design of the post- or leg-type electrode 204 shown in FIG. 6A may, when use pressure 602 is exerted during expected contact of the post- or leg-type electrode 204 with a part of the body, begin to experience sheer forces 606. These may cause the posts/legs of the post- or leg-type electrode 204 to bend and buckle, causing them to fold into each other like the bristles of a broom as they slide across the skin's surface. This distortion of the electrode posts, with multiple posts coupling together as they come into contact, may degrade signal quality. Electrode posts made of material strong enough not to bend and buckle may severely impact comfort for the wearer as such rigid posts are pressed against the skin.

The design of the post- or leg-type electrode 206 shown in FIG. 6B allows it to expand linearly until the legs are fully compressed, or they break, depending on their material of construction. Application of use pressure 602 may cause the legs to sheer outward 608 along the skin's surface, as shown. This design, by deforming intentionally and radially, may avoid the coupling and undesired deformation issues described for the post- or leg-type electrode 204 above, but may still cause discomfort as the legs move across the skin.

When either of the post- or leg-type electrodes 204 and 206 are made from a flexible material more conducive to wearer comfort and conformation to their application surface, a conductivity-enhancing coating may be needed at the ends of the posts or legs to provide adequate sensitivity to the body's electromagnetic field fluctuations. Silver chloride is commonly used for this purpose. However, such a coating is highly susceptible to wear as it abrades against the skin during the repeated dragging of the post or leg ends under pressure during use. In this manner, their performance and thus usefulness may decrease over time.

FIG. 6C illustrates an electrode 400 applied to a selected subject area 604, such as a wearer's scalp. The rails 408 and arc rail braces 410 of the arc rails are configured such that the arc rails are so disposed in relation to the electrode body 402 as to be disposed at a non-perpendicular angle 618 to the selected subject area 604 when the electrode assembly is applied to the selected subject area 604. Arc rails may be adapted to flex when the electrode assembly is applied under pressure to the selected subject area 604, thereby causing the electrode assembly to conform to the subject area in a manner that may improve contact while not impacting comfort.

At least one of the electrode 400, the electrode body 402, the connector base 404, and the arc rails including the rail 408 and arc rail braces 410, may be flexible. This may allow the disclosed electrode 400 to conform naturally to the body by bending asymmetrically, in various stages, when use pressure 602 is applied. First, the rails 408 may bow 610 inward toward the electrode body 402 with initial pressure. When pressed against a curved surface like an arm or the back of the head, the rails 408 may bow 610 to a very high degree of travel to accommodate and conform to the curves of its surface of application. The arc rail braces 410 may then bow 612 outward and compress as pressure increases. The profile of the arc rails 406 may splay 614 outward in a slight rotational bending and flattening. In some embodiments, this may allow the electrode 400 to slide on the selected subject area 604 as well as conform to it. Finally, in embodiments provided with a compressible connector base 404, the connector base 404 may compress 616 to absorb additional forces.

In one embodiment, the electrode 400 may include mechanical features that modify the deformation characteristics of the arc rails. Such electrode assemblies may include at least one arc rail brace of a design or configuration that modifies the deformation characteristics of the electrode assembly. A polymer structure may be overmolded onto at least one of the electrode body and the at least one arc rail to alter the mechanical deformation properties of the electrode assembly. The electrode assembly may also include at least one of at least a partially encapsulating or encapsulated substrate and an arc rail brace to facilitate asymmetrical deformation of the electrode assembly.

FIG. 7A-FIG. 7C illustrate advantages of different electrode geometries 700 in accordance with various embodiments. FIG. 7A illustrates the advantages of top-symmetrical versus top-asymmetrical arc rail spacing configurations and smooth versus edged rail cross-sectional geometries. As shown in the embodiments illustrated in FIG. 5A-FIG. 5H, the electrodes disclosed herein may vary with respect to arc rail spacing, as viewed in a bottom plan view, as well as with respect to their cross-sectional geometry. These variations support optimizations for different applications and different wearers.

The smooth top-symmetrical electrode 702 and the edged top-asymmetrical electrode 704 illustrated herein may each have a first arc rail brace 706, a second arc rail brace 708, a third arc rail brace 710, and a fourth arc rail brace 712. The smooth top-symmetrical electrode 702 may have top-symmetrical arc rails with rails 408 having smooth cross-sectional geometry 714, as seen in electrode 400. The edged top-asymmetrical electrode 704 may have top-asymmetrical arc rails with edged cross-sectional geometry 716, as seen in electrode 538.

The top-symmetry of the smooth top-symmetrical electrode 702 may be achieved by the first arc rail brace 706, second arc rail brace 708, third arc rail brace 710, and fourth arc rail brace 712 each attaching to the electrode body 402 at angles that are symmetrical with respect to a midline 718 bisecting the smooth top-symmetrical electrode 702 along the y-axis as well as a midline 720 bisecting it along the x-axis. The top-asymmetry of the edged top-asymmetrical electrode 704 may be achieved by attaching the first arc rail brace 706 and third arc rail brace 710 as a pair and the second arc rail brace 708 and fourth arc rail brace 712 as a pair, in a manner such that the attachment angles are symmetrical across the y-axis midline 718, but asymmetrical across the x-axis midline 720, giving the edged top-asymmetrical electrode 704 a narrow end 722 and a wide end 724. In some embodiments, the first arc rail brace 706 and third arc rail brace 710 lengths may differ from the lengths of the second arc rail brace 708 and fourth arc rail brace 712.

As previously described, the smooth cross-sectional geometry 714 of the smooth top-symmetrical electrode 702 may provide a more comfortable experience when placed in contact with a part of the body. However, the edged cross-sectional geometry 716 may be more effective in allowing the electrode to pass more easily through hairs encountered in the skin contacted, such as head hair on a wearer's scalp. The top-symmetry of the smooth top-symmetrical electrode 702 leads to similar behavior when the smooth top-symmetrical electrode 702 is moved in a first direction 726 and a second direction 728. In contrast, the top-asymmetry of the edged top-asymmetrical electrode 704 may allow it to part and spread 730 the hairs it encounters when it is moved in the first direction 726, while it alternatively gathers 732 hairs encountered as it moves in the second direction 728.

These attributes may therefore make the smooth top-symmetrical electrode 702 a more advantageous electrode for use in applications where little hair is anticipated, because hair is not expected to be present to provide some cushioning between the electrode and the skin, and hair is not expected to impede the progress of the electrode across the skin when it moves. Conversely, the edged top-asymmetrical electrode 704 may be advantageous where more hair is anticipated, and where electrode contact with the skin may benefit from the spread 730 or gather 732 results when the electrode moves across the skin. It will be readily understood by one of ordinary skill in the art that where the electrode is expected to primarily move in one direction across the skin during use or when being placed in contact with the skin, the edged top-asymmetrical electrode 704 may be oriented one way when a spread 730 behavior is most advantageous at such times, and an opposite way, with respect to the y-axis, when a gather 732 behavior is most advantageous at such times.

FIG. 7B illustrates the advantages of side-symmetrical versus side-asymmetrical arc rail spacing configurations. As shown in the embodiments illustrated in FIG. 5A-FIG. 5H, the electrodes disclosed herein may vary with respect to arc rail spacing, as viewed in a side elevation view. These variations support optimizations for different applications.

The side-symmetrical electrode 734 and the side-asymmetrical electrode 736 illustrated herein may each have a first arc rail brace 706 and a second arc rail brace 708. In one embodiment, such as is shown in electrode 542, the side-symmetrical electrode 734 may also include a third arc rail brace 710 configured similarly to the first arc rail brace 706 and a fourth arc rail brace 712 configured similarly to the second arc rail brace 708, though these are omitted here for simplicity, as will be immediately understood by one of ordinary skill in the art.

The first arc rail brace 706 and second arc rail brace 708 of the side-symmetrical electrode 734 may be equal in length and may attach to the electrode body at angles that are symmetrical across a z-axis midline 738 bisecting the electrode body. Alternatively, as shown for the side-asymmetrical electrode 736, the first arc rail brace 706 and second arc rail brace 708 may differ in length and/or attach to the electrode body at angles that are asymmetrical with respect to the z-axis midline 738. In this manner, the side-asymmetrical electrode 736 may be configured with a low end 740 and a high end 742.

As described with respect to the smooth top-symmetrical electrode 702, symmetry when seen in a side elevation view allows the side-symmetrical electrode 734 to move in similar ways and with similar case in both a first direction 726 and a second direction 728. This may make the side-symmetrical electrode 734 best suited for use on finely-, sparsely-, or un-haired skin surfaces.

In contrast, the side-asymmetrical electrode 736, when moving in a first direction 726, its low end 740 being the leading end in performing the motion as shown, may divide and slide through the hair in a manner that makes it perform well in dense or thick hair that is curly. Alternately, when the side-asymmetrical electrode 736 moves in a second direction 728, such that the high end 742 is the leading end in the motion, it may move over or through hair in a manner that makes it perform well in medium-thickness or medium-density hair that is relatively straight.

While it is not readily visible with regard to the electrodes of FIG. 7A, the rails 408 of smooth top-symmetrical electrode 702 and edged top-asymmetrical electrode 704 may, while sliding among body or head hair, may also bow as described above to provide comfortable continuous contact. This may be more clearly seen in the side-symmetrical electrode 734 and side-asymmetrical electrode 736, but may apply for all electrodes disclosed herein.

It will be readily apprehended by one of ordinary skill in the art that an electrode design may be configured having both the top-asymmetry illustrated in FIG. 7A and the side-asymmetry illustrated in FIG. 7B to further improve performance under certain conditions. This may be accomplished by variations in both the length of the arc rail braces and the angles at which they attach to the electrode body.

FIG. 7C illustrates the advantages pertaining to mono-rail, bi-rail, tri-rail, and multi-rail arc rail quantities. As shown in the embodiments illustrated in FIG. 5A-FIG. 5H, the electrodes disclosed herein may vary with respect to the arc rail quantity with which each electrode is configured. These variations support optimizations for different applications.

The arc rail of a mono-rail electrode 744 may be likened to flexible prosthetic running legs in their ability to flex under pressure without collapsing. Where they are configured with bowed rails, they may also react to a wearer's motion with the smooth rocking motion of a rocking chair, which maintains contact with the floor even as it rocks back and forth. Thus the mono-rail electrode 744 may maintain solid contact with the surface they impinge upon. The mono-rail electrode 744 may be most advantageous for use in configurations where it is desired to pack electrodes densely together or to locate them among other elements. Such a configuration may be seen in the BCI headset with electrodes 1700 of FIG. 17.

The bi-rail electrode 746 and tri-rail electrode 748 similarly exhibit the strength and flexibility of the mono-rail electrode 744. In addition, For many applications, the bi-rail electrode 746 and tri-rail electrode 748 may be advantageous for their ability to maintain solid and continuous contact with the skin despite the wearer's movements. The additional rail of the bi-rail electrode 746 may preserve contact during movements that may cause the electrode to rock from rail to rail in the direction of the x-axis in addition to or instead of rocking along the length of the rails in the direction of the y-axis. The tri-rail electrode 748 may further improve upon this continuity of contact and may provide more continuously contacted surface area, by behaving similarly to a trimaran, which may maintain at least one or two of its three hulls in the water, even under turbulent conditions.

The multi-rail electrode 750 may be implemented with a flexible electrode body supporting any number of arc rails 406. In this manner, a band or fabric may be created that provides sensing clement contact across a broad surface, improving the strength of the signals detected without similarly increasing the noise detected. Thus the multi-rail electrode 750 may support a high-performance, continuous contact, flexible electrode connection with a wearer's arm, head, or other body part, even when the wearer is highly active and mobile, an environment where conventional electrodes may be easily dislodged.

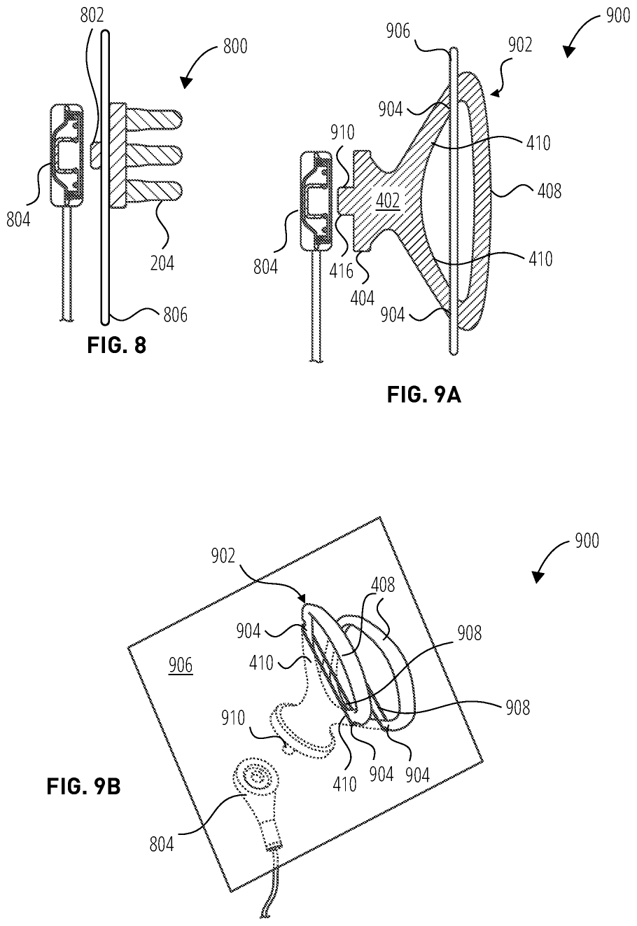

FIG. 8 illustrates a conventional connection to an electrode cable 800. The post- or leg-type electrode 204 introduced in FIG. 2A may be seen, including a male snap connector 802. The male snap connector 802 allows the post- or leg-type electrode 204 to connect easily to equipment for interpreting sensed electromagnetic activity by snapping into an electrode cable with a female snap connector 804, such as is commonly used in sensing applications. The male snap connector 802 may be pressed through an aperture in a fabric 806 before snapping into the electrode cable with a female snap connector 804. In this manner, such electrodes may be readily worn and maintained against the skin. However, such a fabric 806 may add to the use pressure experienced by the user, especially when the full depth of the post- or leg-type electrode 204 excepting the male snap connector 802 may be disposed between a wearer's clothing or other fabric 806 and the wearer's skin.

FIG. 9A and FIG. 9B illustrate a connection to electrode cables 900 in accordance with one embodiment. The electrode 902 illustrated may also include an electrical connection point 416 configured with a male snap connector 910. This may allow the electrode 902 to connect to commonly used sensing and measuring equipment using readily available electrode cables with female snap connectors 804.

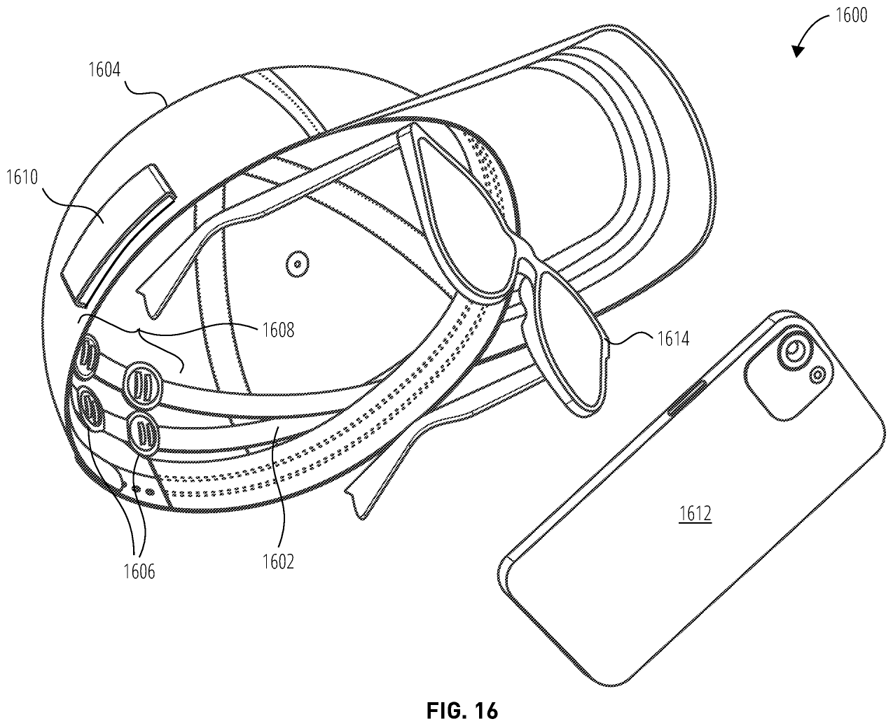

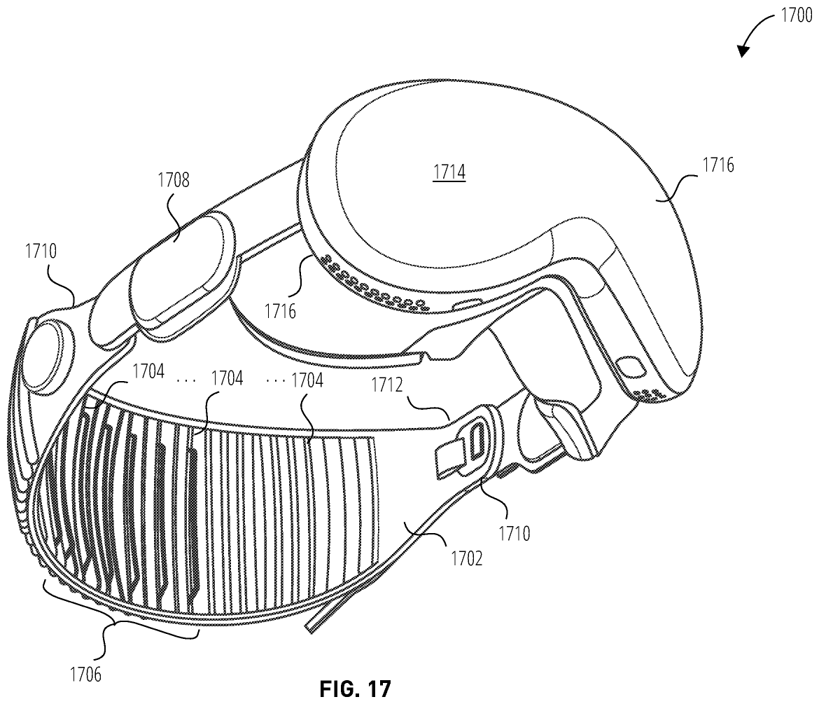

In one embodiment, the arc rail braces 410 of the electrode 902 may be configured with notches 904. These notches 904 may allow the electrode 902 to be pressed through a slit 908 fabric or membrane 906, but to be maintained within the fabric or membrane 906 at a certain depth, as determined by the location of the notches 904. In this manner, the rails 408 of the electrode 902 may be placed in contact with a wearer's skin, while the majority of the rails 408, the electrode body 402, and the connector base 404 protrude behind the fabric or membrane 906. In this manner, the electrode 902 may be held securely, but more comfortably, in contact with the wearer's skin. An example of such a configuration may be seen in the BCI-compatible hat with electrodes 1600 of FIG. 16.

FIG. 10 illustrates a microneedle array 1000 in accordance with one embodiment. The microneedle array 1000 may comprise microneedles 1002 having microneedle bases 1004 conductively engaged through a connecting link 1006. The microneedle array 1000 shown is the most fundamental example of such an array. It exhibits a single bar arrangement, the two microneedles 1002 connected at their microneedle bases 1004 by a rib artifact or connecting link 1006 left behind after processing the substrate from which the microneedles 1002 are formed.

Placing individual microneedles may be both mechanically challenging and time-consuming. Needles may need to point upward to properly interface with the vacuum chuck of a pick-and-place machine. This may be accomplished using a vibrating tray, or through careful release of the needles from their handle wafer without disturbing their orientation. These challenges may be overcome by using microneedle arrays 1000 such as are described herein rather than individual microneedles.

Microneedle arrays 1000 may be created from a contiguous layer of suitable material. For example, a microneedle array 1000 may begin a wafer of silicon, fused silica, or other material, which may undergo wafer processing steps well understood in the art. In one embodiment, a wafer may be etched, and the wafer etching may be stopped just before reaching the handle wafer. In one embodiment, a highly-doped silicon may be used as an electrochemical etch stop to preserve a contiguous underlayer. A silicon-on-insulator (SOI) wafer may be used, allowing the etching to be stopped by the oxide layer in the wafer and allowing the under-layer to serve as the connecting microneedle bases 1004, which may then be bridged by connecting links 1006 formed by sputtered silver or similar coating.

A microneedle array 1000 may thus be created in which microneedles 1002 are linked together into a single structure by connecting links 1006 between the microneedle bases 1004. A continuous layer of microneedles 1002 thus arrayed may be singulated into the desired microneedle arrays 1000 using equally well-understood techniques. Such techniques may include laser cutting, scribe-and-snap, back-side deep reactive ion etching (DRIE), use of a dicing saw, etc. Connecting links 1006 may be selectively removed to separate the needles into arrays of various shapes and sizes to fit the desired microneedle placement geometries. One of ordinary skill in the art will readily understand that multiple additional connecting links 1006 intersecting each microneedle 1002 at different angles may interconnect additional microneedles 1002 with the two illustrated herein.

Microneedle arrays 1000 may be created having microneedles 1002 arranged in a square or rectangular grid pattern, the connecting links 1006 connecting their microneedle bases 1004 through right angle connections, 45-degree connections, both together, or some other configuration. In one embodiment, the microneedle 1002 may form a hexagonal microneedle array 1000, each microneedle base 1004 having six connecting links 1006 leaving it at 60-degree intervals. Microneedles 1002 may be arranged and connected in concentric circles with circumferential and radial connections. Connecting links 1006 may be linear as shown, or may be angular or curvilinear. A number of other variations may be understood by one of ordinary skill in the art.

In some applications, reduction of resistance and impedance may lead to improved performance of the sensing system. Extra surface area at the microneedle bases 1004 of a microneedle array 1000 may reduce the total resistance of the bond joint and may bridge any microneedles 1002 with a high resistance contact. This approach may also reduce the risk that a faulty individual microneedle 1002 bond joint may lead to the release of a needle into the contacted skin tissue. The relatively narrow width of the connecting links 1006 may provide for easy release from the handle wafer. One of ordinary skill in the art will readily apprehend that a variety of materials may be used to achieve the desired results. Exemplary materials include single-crystal silicon, polysilicon, fused silica (amorphous quartz), and other materials.

FIG. 11 illustrates an electrode engaged with skin 1100 in accordance with one embodiment. A schematic view is presented, and is not intended to represent all of the elements to scale. The disclosed electrode 400 may rest on the skin's surface, as shown. In one embodiment, The rails 408 of the electrode 400 may be configured microneedle arrays 1000, such as are described with respect to FIG. 10. The microneedles 1002 of these arrays may penetrate the stratum corneum 102, reaching the more water-rich epidermis 104 upon which the electrode 400 rests. This is shown in greater detail in FIG. 12.

FIG. 12 illustrates microneedles engaged with skin 1200 in accordance with one embodiment. A schematic view is presented, and is not intended to represent all of the elements to scale. As previously described, the keratin outer surface of the skin may exhibit poor conductivity, especially when dry. This outer layer, the stratum corneum 102, is made of shedding and dead keratinocytes and may be covered with a thin residue of sebaceous oils and perspiration. This layer is constantly sloughing off as new keratinocytes push through the epidermis and reach the surface. The stratum corneum 102 forms a thin water barrier over the skin, preventing both outside moisture from entering and body moisture from evaporating through the skin. The stratum corneum 102 is a fraction of the thickness of the epidermis 104, ranging from 10-30 μm (microns) in depth, its thickness varying from one part of the body to another. The scaly keratinocytes, when viewed under magnification, may appear to resemble the cracked surface of a dry river bed.

The microneedles 1002 of the microneedle arrays 1000 may be 10-30 μm (microns) or slight longer. Thus they may not merely rest upon, but may penetrate into the skin's surface, through the scaly, dead keratinocyte layers of the stratum corneum 102 and into the moist, living cell layers of the epidermis 104. The epidermis 104 holds significant amounts of water and electrolytes, making it markedly more conductive than the skin's surface.

By penetrating into these layers, the microneedles 1002 may readily improve the signal-to-noise ratio and thus the performance of electrodes 400 so equipped without relying upon added moisture such as may be provided by gels or pastes. A microneedle base 1004 may be about 50-120 μm (microns), or about the same width as a single human hair. Because of these small dimensions, many microneedles 1002 may be populated on the rail 408 of a single arc rail 406 (many more than the three shown in the schematic view of FIG. 12). For these reasons, microneedle arrays 1000 may further enhance the ability of the disclosed electrodes to detect the minute electromagnetic perturbations associated with bodily function, which are desirable to be measured as indicators of human health, physical condition, or mood.

FIG. 13A-FIG. 13C illustrate additional sensing device configurations 1300 in accordance with one embodiment. Rails 408 are shown configured with EXG sensing material 420 and sensing pads 422, where the sensing pads are populated with various sensor configurations. These representations are not intended to be interpreted as showing such features to scale. Further, they depict exemplary embodiments and are not intended to limit the scope of this disclosure. One of ordinary skill in the art will readily understand that other configurations are possible in accordance with the solution disclosed herein.

FIG. 13A illustrates a rail 408 primarily comprising EXG sensing material 420. As previously described, the EXG sensing material 420 may be electromagnetically capable material which may either be intrinsic to the structure of the electrode as a whole or the rail 408 in whole or in part. In this manner, all or part of the electrode may be capable of passively sensing electromagnetic activity.

The EXG sensing material 420 may be an electromagnetic polymer molded or printed to form the electrode or rail 408. It may be a flexible wire mesh constructed from conductive materials such as gold or graphene and overlain across the electrode or rail 408. It may be configured as a coating of metal or other conductive material. It may include microneedle arrays. It may completely cover the rail 408 or may be configured as discrete sensing elements (sensing pads) embedded in, placed upon, or otherwise configured within the surface of the rail 408.

In addition to the EXG sensing material 420 other sensing elements may be configured discretely as sensing pads. In one embodiment, the sensing pads may be occupied by Functional near-infrared spectroscopy (fNIRS) devices such as the fNIRS emitter 1302 and two fNIRS detectors 1304 shown in FIG. 13A. Such devices may allow the electrode to actively induce signals in a part of the body and detect the results. Other active sensing devices that may be incorporated into the disclosed electrode in a similar manner may include sonogram transmitters and sensors.

In another embodiment, as illustrated in FIG. 13B and FIG. 13C, the sensing pads 422 may be populated with multiple sensors. For example, the rail 408 of FIG. 13B is shown configured with three of the sensing rings 1306 shown in greater detail in FIG. 13C. In one such sensing ring 1306, as illustrated, an fNIRS detector 1304 may be surrounded by a ring of the EXG sensing material 420. The fNIRS detector 1304 and the ring of EXG sensing material 420 may in turn be surrounded by fNIRS emitters such as the four fNIRS emitters 1302 shown. Such an arrangement may be advantageous for installation on such features as the bumps configured on the rails of electrode 520. In this manner, a number of sensing elements may occupy each bump, including the EXG sensing material 420, which in such an embodiment may or may not coat or be intrinsic to the rail 408 or other portions of the electrode.

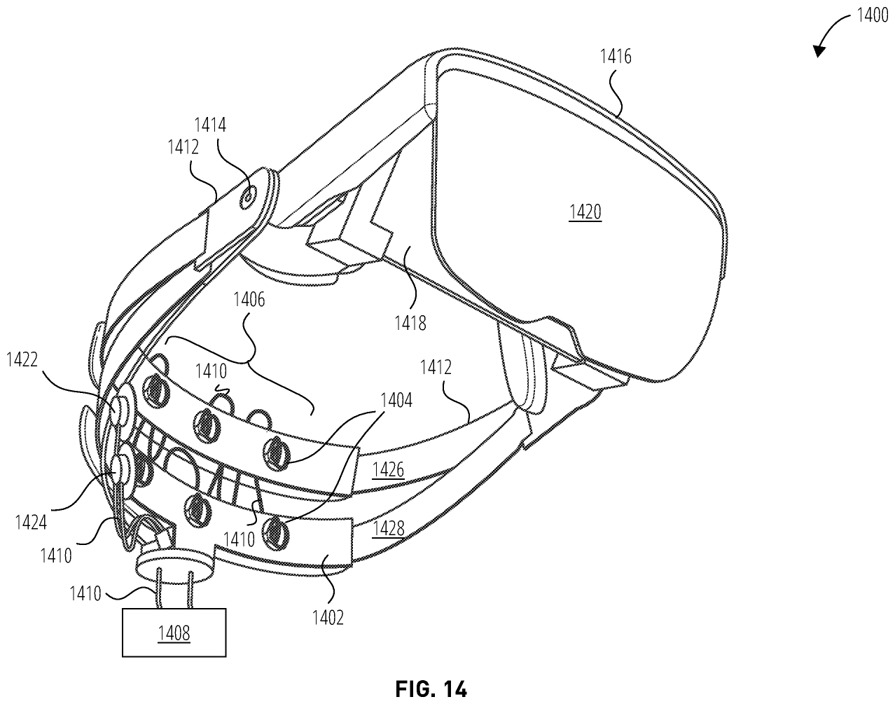

FIG. 14 illustrates a BCI headset with electrodes 1400 in accordance with one embodiment. The BCI headset with electrodes 1400 may comprise an accessory strap 1402 configured with sockets 1404 to accept electrode assemblies in an electrode assembly array 1406 and transmit their output signals to a BCI AFE and digital module 1408 through electrode cables 1410. The accessory strap 1402 may be further configured with earpieces 1412 with attachment points 1414 for a visor 1416 configured to hold a smartphone digital module 1418.

The sockets 1404 of the accessory strap 1402 may be configured to accept the electrode assemblies of the electrode assembly array 1406. These may comprise the electrodes disclosed herein. The electrodes of the electrode assembly arrays 1406 may snap into sockets 1404 that are hard-wired to a connector that may provide a connection to the BCI AFE and digital module 1408. While the electrode assembly array 1406 illustrated comprises six electrodes 400 positioned at the rear of the accessory strap 1402, it will be readily understood by one of ordinary skill in the art that other embodiments may include different numbers of the various disclosed sockets and electrodes arranged in different patterns and locations.

The accessory strap 1402 may connect to a BCI AFE and digital module 1408. In FIG. 14 this is shown as located external to the BCI headset with electrodes 1400 for exemplary purposes. The BCI AFE and digital module 1408 may be incorporated in whole or part into the BCI headset with electrodes 1400 or may be distributed across multiple hardware components as described below. The sockets 1404 may be configured with wired attachments running to the BCI AFE and digital module 1408 through electrode cables 1410. The BCI AFE and digital module 1408 may be able to perform AFE processing on output signals received from the electrodes and may be equipped to perform digital processing or to transmit the results of AFE processing through a wired or wireless connection to a digital module for digital processing. This digital module may comprise an internal BCI digital module or may be included in an external computing environment such as the smartphone digital module 1418, a cloud server, or other computing device configured to perform digital processing, further signal interpretation or transformation, and/or display results from or based on the digital processing. In one embodiment, the BCI AFE and digital module 1408 may be a complete BCI capable of performing AFE and digital processing, and may wirelessly transmit the results to the smartphone digital module 1418 and/or an external display device, such as a cloud server or other computing device for further interpretation, transformation, and/or display.

The earpieces 1412 configured to either side of the accessory strap 1402 may assist in maintaining the electrode assembly array 1406 in contact with a selected subject area, which may be the scalp and skull of a wearer. In one embodiment, the earpieces 1412 may include attachment points 1414 configured to removably or permanently attach the accessory strap 1402 to the visor 1416. In one embodiment, the attachment points 1414 may include conductive contacts capable of carrying wired electrical signals from the accessory strap 1402 to the visor 1416 and, if a suitable connection is provided, the smartphone digital module 1418. The visor 1416 may be a wearable device configured with a reflective yet transparent lens 1420, such that the smartphone digital module 1418 display may be visible both inward to the wearer and outward to others in proximity to and engaging with the wearer.

The smartphone digital module 1418 may include an application configured to perform digital processing, interpretation, and/or transformation of signals received over wired or wireless connections to the electrode assembly array 1406, wired or wireless connections to the BCI AFE and digital module 1408, or wired or wireless connections to another computing device. The application may configure or update the smartphone digital module 1418 display based on the results of such processing. In this manner, the electrode assembly array 1406 may support the functionality and utility of an AR/VR headset through the electrical and mechanical connection provided by the accessory strap 1402 between the electrode assembly array 1406 and a smartphone digital module 1418 display.

In one embodiment, a ground electrode 1422 and a reference electrode 1424 may be included in the electrode assembly array 1406. In another embodiment, as seen in FIG. 14, a separate ground electrode 1422 and a separate reference electrode 1424 may be configured to attach through electrode cables to the BCI AFE and digital module 1408 in support of AFE processing.

In one embodiment, the accessory strap 1402 may include a top band 1426 and a bottom band 1428, each or either of which may be disposed with electrodes in the electrode assembly array 1406, as shown. The top band 1426 and the bottom band 1428 may be movably or immovably joined at the attachment points 1414, or at another point along the earpieces 1412. In this manner, the bands of the accessory strap 1402 may be configured to be adjustable. In one embodiment, the top band 1426 may be rotated upward with respect to the bottom band 1428, allowing the electrode assembly array 1406 to be adjusted in height, such that the electrode positions may be moved across the wearer's scalp and skull toward the top of the head.

The disclosed electrodes may facilitate such adjustment during wear and use by conforming to the skull and scalp and by sliding easily and painlessly through hair, as described in detail with respect to FIG. 6C, FIG. 7A, and FIG. 7B. In contrast, when conventional electrodes are used in such a configuration, they must be placed carefully with respect to their design and then manipulated carefully to get them into the correct position when such a headset is donned, because of their performance limitations and the difficulty and discomfort attending any adjustment once they are in place on a wearer's head. The disclosed electrode assemblies configured in a BCI headset with electrodes 1400 may thus represent a significant improvement in performance, usability, and comfort.

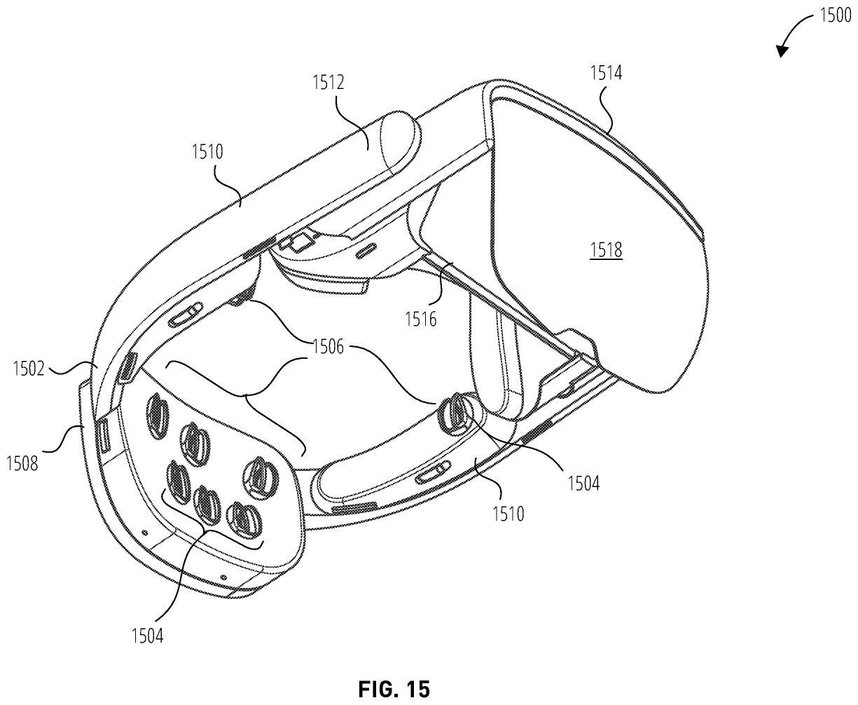

FIG. 15 illustrates a BCI headset with electrodes 1500 in accordance with one embodiment. The BCI headset with electrodes 1500 may comprise an accessory strap 1502 configured with sockets 1504 to accept electrode assemblies in an electrode assembly array 1506 and transmit their output signals to a BCI AFE and digital module 1508 The accessory strap 1502 may be further configured with earpieces 1510 with attachment points 1512 for a visor 1514 configured to hold a smartphone digital module 1516.

The sockets 1504 of the accessory strap 1502 may be configured to accept the electrode assemblies of the electrode assembly array 1506. These may comprise the electrodes disclosed herein. The electrodes of the electrode assembly arrays 1506 may snap into sockets 1504 that are hard-wired to the BCI AFE and digital module 1508. While the electrode assembly array 1506 illustrated comprises six electrodes 400 positioned at the rear of the accessory strap 1502 and one on each earpiece 1510, it will be readily understood by one of ordinary skill in the art that other embodiments may include different numbers of the various disclosed sockets and electrodes arranged in different patterns and locations.

The accessory strap 1502 may incorporate all or part of a BCI AFE and digital module 1508. In FIG. 15 this is shown as located at the rear of the BCI headset with electrodes 1500 for exemplary purposes. The BCI AFE and digital module 1508 may be positioned at some other location or may be distributed across multiple hardware components as described below. The sockets 1504 may be configured with wired attachments running to the BCI AFE and digital module 1508 through the earpiece 1510 and accessory strap 1502. The BCI AFE and digital module 1508 may be able to perform AFE processing on output signals received from the electrodes and may be equipped to perform digital processing or to transmit the results of AFE processing through a wired or wireless connection to a digital module for digital processing. This digital module may comprise an internal BCI digital module or may be included in an external computing environment such as the smartphone digital module 1516, a cloud server, or other computing device configured to perform digital processing, further signal interpretation or transformation, and/or display results from or based on the digital processing. In one embodiment, the BCI AFE and digital module 1508 may be a complete BCI capable of performing AFE and digital processing, and may wirelessly transmit the results to the smartphone digital module 1516 and/or an external display device, such as a cloud server or other computing device for further interpretation, transformation, and/or display.

The earpieces 1510 configured to either side of the accessory strap 1502 may assist in maintaining the electrode assembly array 1506 in contact with a selected subject area, which may be the scalp and skull of a wearer. In one embodiment, the earpieces 1510 may include attachment points 1512 configured to removably or permanently attach the accessory strap 1502 to the visor 1514. In one embodiment, the attachment points 1512 may include conductive contacts capable of carrying wired electrical signals from the accessory strap 1502 to the visor 1514 and, if a suitable connection is provided, the smartphone digital module 1516. The visor 1514 may be a wearable device configured with a reflective yet transparent lens 1518, such that the smartphone digital module 1516 display may be visible both inward to the wearer and outward to others in proximity to and engaging with the wearer.

The smartphone digital module 1516 may include an application configured to perform digital processing, interpretation, and/or transformation of signals received over wired connections to the electrode assembly array 1506, wired connections to the BCI AFE and digital module 1508, or wirelessly from the BCI AFE and digital module 1508 or another computing device. The application may configure or update the smartphone digital module 1516 display based on the results of such processing. In this manner, the electrode assembly array 1506 may support the functionality and utility of an AR/VR headset through the electrical and mechanical connection provided by the accessory strap 1502 between the electrode assembly array 1506 and a smartphone digital module 1516 display.

In one embodiment, ground and reference electrodes may be included in the electrode assembly array 1506. In another embodiment, separate ground and reference electrodes may be configured to attach through electrode cables to the BCI AFE and digital module 1508 in support of AFE processing.

FIG. 16 illustrates a BCI-compatible hat with electrodes 1600 in accordance with one embodiment. The BCI-compatible hat with electrodes 1600 may comprise an accessory strap 1602 installed within a hat or cap 1604 and configured with sockets 1606 to accept electrode assemblies in an electrode assembly array 1608 attached through a wired connection to an AFE processing module 1610 also installed within the hat or cap 1604. The hat or cap 1604 may support the electrode assembly array 1608 in maintaining contact with the scalp and skull of a wearer.

The sockets 1606 of the accessory strap 1602 may be configured to accept the electrode assemblies of the electrode assembly array 1608. These may comprise the electrodes disclosed herein. The electrodes of the electrode assembly array 1608 may snap into sockets 1606 that are hard-wired to the AFE processing module 1610. While the electrode assembly array 1608 illustrated comprises two rows of two electrodes 400 positioned at the rear of the accessory strap 1602, it will be readily understood by one of ordinary skill in the art that any of the electrodes disclosed herein may populate any spot in the electrode assembly array 1608, and other embodiments may include different numbers of electrodes arranged in different patterns and locations.

The accessory strap 1602 or sockets 1606 may incorporate all or part of the AFE processing module 1610. The sockets 1606 may be configured with wired attachments running to the AFE processing module 1610 through, behind, or along the accessory strap 1602 or the hat or cap 1604. In FIG. 16 the AFE processing module 1610 is shown on one side of the hat or cap 1604 but may be positioned at the rear of the hat or cap 1604, or some other location. The AFE processing module 1610 may be able to perform AFE processing on output signals received from the electrodes and may be equipped to transmit the results of AFE processing through a wired or wireless connection to a digital module for digital processing. This digital module may comprise an external computing environment such as the smartphone digital module 1612, the eyepiece accessory 1614, a cloud server, or other computing device configured to perform digital processing, further signal interpretation or transformation, and/or display results from or based on the digital processing. In one embodiment, the AFE processing module 1610 may be a complete BCI capable of performing AFE and digital processing, and may wirelessly transmit the results to the smartphone digital module 1612 and/or eyepiece accessory 1614, or to an external display device, such as a cloud server or other computing device for further interpretation, transformation, and/or display.

In one embodiment, the BCI-compatible hat with electrodes 1600 may be in wireless communication with an eyepiece accessory 1614, such as smart glasses or AR/VR goggles. In one embodiment, the BCI-compatible hat with electrodes 1600 may be in wireless communication with the smartphone digital module 1612, which may also be in communication with the eyepiece accessory 1614. The smartphone digital module 1612 and/or the eyepiece accessory 1614 may include an application configured to perform digital processing, interpretation, and/or transformation of signals received wirelessly from the AFE processing module 1610, and/or configure or update a display based on the results of such processing. In this manner, the electrode assembly array 1608 may support the functionality and utility of an augmented reality/virtual reality (AR/VR) wearable system.

In one embodiment, ground and reference electrodes may be included in the electrode assembly array 1608. In another embodiment, separate ground and reference electrodes may be configured to attach through electrode cables to the BCI AFE and smartphone digital module 1612.

FIG. 17 illustrates a BCI headset with electrodes 1700 in accordance with one embodiment. The BCI headset with electrodes 1700 may comprise an accessory strap 1702 configured with sockets 1704 to accept electrode assemblies in an electrode assembly array 1706 and transmit their output signals to an AFE processing module 1708. The accessory strap 1702 may be further configured with earpieces 1710 with attachment points 1712 for a smart visor digital module 1714 having inward- and outward-facing AR/VR displays 1716.

The sockets 1704 of the accessory strap 1702 may be configured to accept the electrode assemblies of the electrode assembly array 1706. These may comprise the electrodes disclosed herein. The electrodes of the electrode assembly arrays 1706 may snap into sockets 1704 that are hard-wired to the AFE processing module 1708. While the electrode assembly array 1706 illustrated comprises seven long, flat mono-rail electrodes 744 positioned vertically at the rear of the accessory strap 1702, it will be readily understood by one of ordinary skill in the art that other embodiments may include different numbers of the various disclosed sockets and electrodes arranged in different patterns and locations.

The accessory strap 1702 may incorporate all or part of the AFE processing module 1708. In FIG. 17 this is shown as located in an earpiece 1710 for exemplary purposes. The AFE processing module 1708 may be positioned at the rear of the accessory strap 1702 or some other location. The sockets 1704 may be configured with wired attachments running to the AFE processing module 1708 through, along, or behind the accessory strap 1702. The AFE processing module 1708 may be able to perform AFE processing on output signals received from the electrodes and may be equipped to transmit the results of AFE processing through a wired or wireless connection to a digital module for digital processing. This digital module may comprise an external computing environment such as the smart visor digital module 1714, a cloud server, or other computing device configured to perform digital processing, further signal interpretation or transformation, and/or display results from or based on the digital processing. In one embodiment, the AFE processing module 1708 may be a complete BCI capable of performing AFE and digital processing, and may wirelessly transmit the results to the smart visor digital module 1714 and/or an external display device, such as a cloud server or other computing device for further interpretation, transformation, and/or display.

The earpieces 1710 configured to either side of the accessory strap 1702 may assist in maintaining the electrode assembly array 1706 in contact with a selected subject area, which may be the scalp and skull of a wearer. In one embodiment, the earpieces 1710 may include attachment points 1712 configured to removably or permanently attach the accessory strap 1702 to the smart visor digital module 1714. In one embodiment, the attachment points 1712 may include conductive contacts capable of carrying wired electrical signals from the accessory strap 1702 to the smart visor digital module 1714, which may then include the AFE processing module 1708. The smart visor digital module 1714 may be a wearable computing device in a binocular form factor and may be configured with both inward-and outward-facing AR/VR displays 1716 for communicating information to the wearer and others in proximity to and engaging with the wearer.

The smart visor digital module 1714 may include an application configured to perform digital processing, interpretation, and/or transformation of signals received over wired connections to the electrode assembly array 1706, wired connections to the AFE processing module 1708, or wirelessly from the AFE processing module 1708 or another computing device. The application may configure or update the AR/VR displays 1716 based on the results of such processing. In this manner, the electrode assembly array 1706 may support the functionality and utility of an AR/VR headset through the electrical and mechanical connection provided by the accessory strap 1702 between the electrode assembly array 1706 and an AR/VR display 1716.

In one embodiment, ground and reference electrodes may be included in the electrode assembly array 1706. In another embodiment, separate ground and reference electrodes may be configured to attach through electrode cables to the AFE processing module 1708.

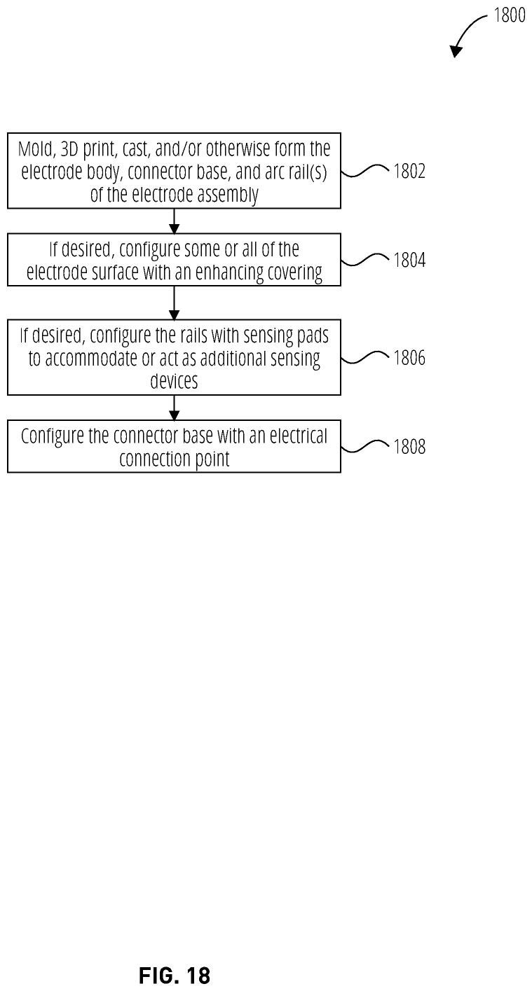

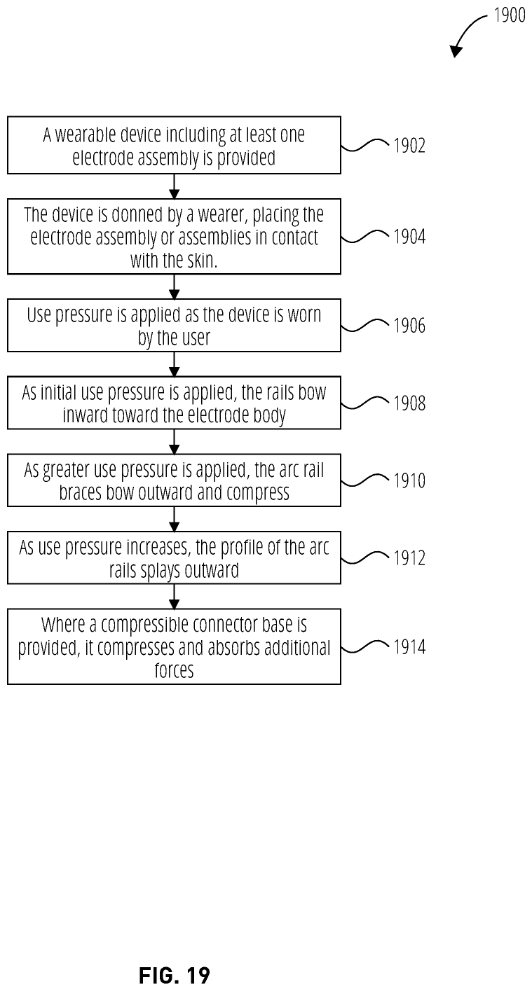

FIG. 18 illustrates a fabrication routine 1800 in accordance with one embodiment. Although the example fabrication routine 1800 depicts a particular sequence of operations, the sequence may be altered without departing from the scope of the present disclosure. For example, some of the operations depicted may be performed in parallel or in a different sequence that does not materially affect the function of the fabrication routine 1800. In other examples, different components of an example device or system that implements the fabrication routine 1800 may perform functions at substantially the same time or in a specific sequence.

According to some examples, the method includes molding, 3D printing, casting, and/or otherwise forming the electrode body, connector base, and arc rail(s) of the electrode assembly at block 1802. The electrode assembly may include arc rails made from a conductive material. The electrode assembly may also include arc rails made with a non-conductive structure that is at least partially encapsulated with a conductive material. Three-dimensional printers or injection molding devices supplied with a conductive polymer, a smart material, or another suitable substrate media, may be used to print or mold electrode bodies having the desired shape. The electrode bodies may also be cast, stamped, carved, laser jet cut, or water jet cut from the desired materials. Materials used for these electrode bodies may include elastomeric, polymer, and metal materials, which may be flexible or rigid. Materials used may be conductive for single-terminal electrode performance, may be insulative with conductive channels within the electrode body, or may combine these techniques across the components of the electrode assembly. Different arc rail spacing configurations, arc rail quantities, rail cross-sectional geometries, and rail contact surface features, as well as various substrate and coating materials for the electrode body and/or its arc rails, may be used to optimize for specific electrode applications and wearers.

According to some examples, the method includes, if desired, configuring some or all of the electrode surface with an enhancing covering at block 1804. The arc rails may be configured with coatings or patches of highly conductive materials through electroplating, spluttering, and other techniques well understood in the art. Such materials may include electromagnetic polymers, mesh, plating, coating, or embedded wires formed from high-conductivity metals such as gold or silver, or other materials such as graphene.

Graphene is fundamentally a single layer of the commonly-found mineral graphite: a layer of sp²-bonded carbon atoms arranged in a honeycomb (hexagonal) lattice. Graphite is essentially made up of hundreds of thousands of layers of graphene. In actuality, the structural make-up of graphite and graphene, and the method of how to create one from the other, is slightly different, and graphene offers some properties that exceed those of graphite as it is isolated from its “mother material.”

Graphene is commonly used in thermochemistry as the standard state for defining the heat formation of compounds made from carbon. It is found naturally in three different forms: crystalline flake, amorphous, and lump or vein graphite. Depending on its form, it may be used for a number of different applications. Graphene may also be separated from graphite through micromechanical exfoliation. Graphene may be peeled off of graphite. After completion of peeling, multiple layers of graphene may remain on the tape.

Graphite is naturally a very brittle compound and cannot be used as a structural material on its own due to its sheer planes (although it is often used to reinforce steel). Graphene, on the other hand, is the strongest material ever recorded, more than three hundred times stronger than A36 structural steel, at 130 gigapascals, and more than forty times stronger than diamond. Carbon itself does not conduct electricity, but its allotrope graphite does. This is because graphite has a “free” electron in its outer shell that allows it to conduct some electricity. Metals have many free electrons and therefore are much better conductors of electricity. Due to graphite's planar structure, its thermal, acoustic, and electronic properties are highly anisotropic, meaning that phonons travel much more easily along the planes than they do when attempting to travel through the planes. Graphene, on the other hand, being a single layer of atoms and having very high electron mobility, offers high levels of electronic conduction due to the occurrence of a free pi (π) electron for each carbon atom.

According to some examples, the method includes if desired, configuring the rails with sensing pads to accommodate or act as additional sensing devices at block 1806. Additional sensing components may be formed on, attached to, or embedded within the arc rails, their signals being carried by conductive structures or coatings configured onto or within the electrode bodies. Such active sensing components may include fNIRS devices as illustrated in and described with respect to FIG. 13A-FIG. 13C.

The coating applied in block 1804 or the sensing pads developed in block 1806 may incorporate microelectromechanical system (MEMS) microneedles, which may be placed individually or in microneedle arrays on the user-facing surfaces of the rails 408. These may include microneedle arrays 1000 such as are illustrated in and described with respect to FIG. 10.

According to some examples, the method includes configuring the connector base with an electrical connection point at block 1808. The electrode assemblies may be configured with a continuous conductive material between the electrode body and a BCI. In one embodiment, this may be a fine wire material with which the electrode is overmolded for flexibility and stability. An electrical connection point made of a different material from the electrode body may be configured at the connector base of the electrode body. These completed electrodes may finally be installed in a wearable BCI enclosure and may be configured to attach to industry-standard electrode wiring or cables.

FIG. 19 illustrates a use routine 1900 in accordance with one embodiment. Although the example use routine 1900 depicts a particular sequence of operations, the sequence may be altered without departing from the scope of the present disclosure. For example, some of the operations depicted may be performed in parallel or in a different sequence that does not materially affect the function of the use routine 1900. In other examples, different components of an example device or system that implements the use routine 1900 may perform functions at substantially the same time or in a specific sequence.

According to some examples, a wearable device including at least one electrode assembly is provided at block 1902. The electrode assembly may comprise the features illustrated for the exemplary electrode 400 in FIG. 4A-FIG. 4G, including an electrode body, a connector base, and arc rails configured with sensing elements, and may incorporate a number of mechanical features, materials, and discrete sensors to enhance both its mechanical and electrical capabilities, as disclosed herein. Any of the embodiments illustrated and described herein may be configured into a wearable device. Exemplary wearable devices are illustrated in FIG. 14-FIG. 17.

According to some examples, the device is donned by a wearer, placing the electrode assembly or assemblies in contact with the skin at block 1904. According to some examples, a use pressure is applied as the device is worn by the user at block 1906. The electrode assembly may conform naturally to the body and may bend asymmetrically, in various stages, when use pressure is applied. This ability of the electrode assembly to conform to the surface it is applied to may be seen most readily in FIG. 6C and FIG. 7B.

As initial use pressure is applied, the rails bow inward toward the electrode body at block 1908. According to some examples, as greater use pressure is applied, the arc rail braces bow outward and compress at block 1910. According to some examples, as use pressure increases, the profile of the arc rails splays outward at block 1912. According to some examples, where a compressible connector base is provided, it compresses and absorbs additional forces at block 1914. FIG. 6C provides a visualization of how the electrode assembly may accomplish the steps of blocks 1908-1914.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed field programmable gate array (FPGA), for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of disclosed subject matter is not limited to the depicted embodiments but is rather set forth in the following Claims.

What is claimed is:

1. An electrode assembly, comprising:
an electrode body; and
at least one arc rail attached to and extending from the electrode body;
wherein the at least one arc rail includes at least one sensing element for sensing the state of a particular property of a selected subject area when the sensing element is applied by the at least one arc rail to the selected subject area; and
wherein the at least one arc rail is so disposed in relation to the electrode body as to be disposed at a non-perpendicular angle to the selected subject area when the electrode assembly is applied to the selected subject area.

2. The electrode assembly of claim 1, wherein the sensing element is additionally configured to be driven as a stimulation element.

3. The electrode assembly of claim 1, wherein a polymer structure is overmolded onto at least one of the electrode body and the at least one arc rail to alter the mechanical deformation properties of the electrode assembly.

4. The electrode assembly of claim 1, wherein the structure of at least one of the electrode assembly, the electrode body, and the at least one arc rail, is flexible.

5. The electrode assembly of claim 1, wherein the at least one arc rail is made from a conductive material.

6. The electrode assembly of claim 1, wherein the at least one arc rail is a non-conductive structure that is at least partially encapsulated with a conductive material.

7. The electrode assembly of claim 1, wherein the electrode assembly is a dry electrode.

8. The electrode assembly of claim 1, wherein the electrode assembly is an active electrode.

9. The electrode assembly of claim 1, wherein the at least one arc rail is a partial loop.

10. The electrode assembly of claim 1, wherein the at least one arc rail is adapted to flex when the electrode assembly is applied under pressure to the selected subject area to thereby cause the electrode assembly to conform to the selected subject area.

11. The electrode assembly of claim 10, wherein the at least one arc rail further comprises at least one sensing pad.

12. The electrode assembly of claim 10, further comprising at least one arc rail brace that modifies the deformation characteristics of the electrode assembly.

13. The electrode assembly of claim 10, wherein the at least one arc rail further comprises at least one additional sensing device.

14. The electrode assembly of claim 10, wherein the at least one arc rail comprises mechanical features that modify at least one of the deformation characteristics and the sensing characteristics of the electrode assembly.

15. The electrode assembly of claim 14, wherein the mechanical features include at least one of a slit, a ridge, a bump, a groove, a divot, a hole, a dimple, an overmolded substrate, at least a partial encapsulating substrate, a conductive coating, and an arc rail brace.

16. The electrode assembly of claim 14, wherein the mechanical features include at least one of a at least a partial encapsulating substrate and an arc rail brace to facilitate asymmetrical deformation of the electrode assembly.

17. A system comprising:
an analog front end (AFE) configured to receive output signals from at least one electrode assembly and transmit the output signals to a digital module for processing;
an accessory strap including sockets to receive the at least one electrode assembly and configured to deliver the output signal from the at least one electrode assembly to the AFE;
wherein the at least one electrode assembly includes:
an electrode body; and
at least one arc rail attached to and extending from the electrode body;
wherein the at least one arc rail includes at least one sensing element for sensing the state of a particular property of a selected subject area when the sensing element is applied by the at least one arc rail to the selected subject area; and
wherein the at least one arc rail is so disposed in relation to the electrode body as to be disposed at a non-perpendicular angle to the selected subject area when the at least one electrode assembly is applied to the selected subject area.

18. The system of claim 17, wherein the at least one arc rail is adapted to flex when the electrode assembly is applied under pressure to the selected subject area to thereby cause the electrode assembly to slide on the selected subject area.

19. The system of claim 17, wherein the at least one arc rail is made from a conductive material.

20. The system of claim 17, wherein the accessory strap is configured to connect electrically and mechanically to an Augmented Reality display or a Virtual Reality display.
